(19) United States
(12) Patent Application Publication
(10) Pub. No.: US 2026/0303161 A1
(43) Pub. Date: Oct. 1, 2026

(54) LOW COMPLEXITY O(N) ALGORITHM FOR N-BEAM TRUE TIME DELAY BEAMFORMERS BASED ON SPARSE FACTORIZATION OF THE DELAY VANDERMONDE MATRIX (DVM)

(71) Applicants: Habarakada Liyanachchi Prabath Arjuna Madanayake, Miami, FL (US); Sirani Kanchana Mututhanthrige Perera, Miami, FL (US)

(72) Inventors: Habarakada Liyanachchi Prabath Arjuna Madanayake, Miami, FL (US); Sirani Kanchana Mututhanthrige Perera, Miami, FL (US)

(73) Assignee: The Florida International University Board of Trustees, Miami, FL (US)

(21) Appl. No.: 19/382,463

(22) Filed: Nov. 7, 2025

Related U.S. Application Data
(63) Continuation-in-part of application No. 19/095,898, filed on Mar. 31, 2025.

(51) Int. Cl. H04B 7/06

(52) U.S. Cl. CPC H04B 7/0617

(57) ABSTRACT

Systems and methods for reducing the complexity of a delay Vandermonde matrix (DVM) of a beamformer are provided. Beamformed outputs are generated using approximate DVM (ADVM) with approximate discrete Fourier transform (ADFT), achieving O(N) complexity. The beamformer operates at baseband or intermediate frequency (IF), substantially lower than RF, enabling a scalable, low-power architecture with simplified circuit design, reduced processing overhead, and lower system cost by avoiding the need for high-frequency RF components.

### CROSS-REFERENCE TO A RELATED APPLICATION

This present application is a continuation-in-part application of U.S. application Ser. No. 19/095,898, filed Mar. 31, 2025, the disclosure of which is hereby incorporated by reference in its entirety, including all figures, tables, and drawings.

### GOVERNMENT SUPPORT

This invention was made with government support under 2229471, and 2229473 awarded by the National Science Foundation. The government has certain rights in the invention.

### BACKGROUND

The parent application (U.S. patent application Ser. No. 19/095,898) describes the use of an approximate discrete Fourier transform (ADFT) to implement a delay Vandermonde matrix (DVM) enables significant computational savings in beamforming systems operating at high radio frequencies (RF). This approach effectively reduces the complexity of matrix operations required for beam steering and signal alignment in high-frequency domains, making it particularly useful in real-time and high-throughput RF applications.

However, many modern communication systems operate across multiple frequency bands, including baseband and an intermediate frequency (IF). In such systems, beamforming must often be performed not only at high-frequency RF but also within lower-frequency domains, where the computational burden remains substantial. Signal processing at low frequencies presents a valuable opportunity to significantly reduce computational complexity, as the lower clock rates and bandwidth requirements allow for more flexible and efficient algorithmic implementations. Additionally, beamforming at the baseband or the IF can be achieved using lower-cost, general-purpose digital hardware, avoiding the need for specialized, high-speed semiconductor components typically required at high-frequency RF. This makes the system cheaper to manufacture, easier to implement, and more scalable across different platforms. Yet, existing approaches do not fully leverage these advantages in conjunction with ADFT-based beamforming. Therefore, there is a need for an improved method that extends the computational benefits of ADFT-based DVM approximation to low-frequency domains such as the baseband or the IF, enabling efficient, scalable, and cost-effective beamforming across a broader range of system architectures and operating frequency regimes.

### BRIEF SUMMARY

Embodiments of the subject invention provide novel and advantageous systems and methods for generating N-beam true time delay (TTD) beamformers based on sparse factorization of the delay Vandermonde matrix (DVM) for low complexity O(N) algorithm (e.g., utilized to describe delay and sum operations in beamforming of the beamformer). The beamformer can be a TTD multibeam beamformer comprising at least one antenna or antenna array (e.g., radio frequency (RF) antenna or antenna array). An approximate DVM (ADVM) algorithm (e.g., an N-point ADVM) can be used that utilizes highly sparse factors, thereby reducing the gain-delay complexity of the DVM-vector product to O(N). The reduction is achieved by applying approximate discrete Fourier transform (ADFT), with DFT matrices replaced by ADFT matrices. The beamformer is implemented at baseband or an intermediate frequency (IF) lower than the high-frequency RF signals, enabling efficient hardware implementation through optimized circuit resource utilization, decreased signal processing requirements, and improved scalability across deployment scenarios.

In an embodiment, a beamformer can comprise: a plurality of antennas, the plurality of antennas being a plurality of RF antennas configured to receive RF signals; a plurality of amplifiers respectively connected (e.g., electrically connected and/or directly physically connected) to the plurality of antennas; a plurality of filters respectively connected (e.g., electrically connected and/or directly physically connected) to the plurality of amplifiers; and a plurality of converters respectively connected (e.g., electrically connected and/or directly physically connected) to the plurality of filters. The beamformer can be a TTD multibeam beamformer and can utilize a DVM to describe delay and sum operations in beamforming of the beamformer. The DVM utilized by the beamformer can have a complexity of O(N). The beamformer can be implemented at baseband and/or an IF, the baseband or the IF being lower in frequency than the RF signals, thereby facilitating a scalable beamforming architecture with simplified circuit design, reduced signal processing overhead, and minimized system cost. The DVM can be configured and/or constructed to operate at the baseband or the IF, and this can be done via performing down-conversion operations of the RF signals to the baseband or the IF, thereby facilitating spatial modulation of matrix elements. The RF signals can be down-converted to the baseband by mixing the RF signals with cosine and/or sine waves, or the RF signals being down-converted to the IF by mixing the RF signals with a sine and/or cosine wave. The down-conversion operations can be applicable to both receive-mode systems and transmit-mode systems, thereby enabling a unified architecture that reduces hardware complexity. The beamformer can further comprise a signal flow graph that can implement an O(N) delay-amplifier algorithm. The signal flow graph can be modified by appending a phase-rotator having a β value to each α delay element value, where each α delay element value corresponds to a delay line (e.g., of the signal flow graph) and each β value corresponds to an amplification (e.g., of the signal flow graph). The beamformer can generate (e.g., via a chip of the beamformer that may be electrically connected to the plurality of antennas) output beamformed signals by running and/or applying an approximate DVM (ADVM) algorithm at the baseband or the IF; the ADVM algorithm can be implemented using at least one approximate discrete Fourier transform (ADFT) to perform wideband multibeam beamforming to reduce computational complexity to O(N); and computations of the at least one ADFT can be distributed across p parallel processors to reduce the computational complexity to O(N/p), thereby enabling concurrent processing of signal components and improving overall processing efficiency. The beamformer can be configured for wireless systems with fractional bandwidths below approximately 30%, thereby reducing implementation complexity and deployment cost relative to full-bandwidth TTD beamformers.

The beamformer can be operable in continuous-time and/or discrete-time modes using analog signal processing, digital signal processing, switched-capacitor techniques, and/or switched-current techniques, thereby enabling cost-effective, flexible, and power-efficient implementations. The beamformer can be mapped to custom standard cell libraries and taped out by completing a digital integrated circuit (IC) layout for fabrication. The beamformer can be embedded in radio access network (RAN) hardware. The beamformer can be configured to be used in (and/or can be applicable to) massive multiple-input multiple-output (MIMO), fifth-generation (5G), sixth-generation (6G), Next Generation (NextG), Future Generation (FutureG), holographic MIMO, full-duplex, and/or integrated communications and sensing systems. The beamformer can further comprise: analog integrated circuits based on complementary metal-oxide-semiconductor (CMOS) techniques (e.g., low-cost CMOS techniques) and/or multiple semiconductor technologies; discrete-time digital processing circuitry employing at least one of Von Neumann architectures, graphics processing units (GPUs), matrix-vector processing methods, tensor cores, systolic arrays, and/or analog-digital hybrid techniques including compute-in-memory; and/or digital logic implemented on at least one of digital signal processors (DSPs), field programmable gate arrays (FPGAs), and radio frequency system-on-chip (RF SoC) platforms using hardware description language (HDL) coding, thereby enabling scalable, energy-efficient, real-time beamforming. The beamformer can have a sampling rate (e.g., a Nyquist rate) of at least 1 gigasamples per second (GS/s) (e.g., at least 16 GS/s, at least 32 GS/s, at least 48 GS/s, or at least 64 GS/s). The beamformer can have a bandwidth of at least 1 gigahertz (GHz) (e.g., at least 10 GHz, at least 16 GHZ, at least 20 GHz, at least 24 GHz, at least 30 GHz, or at least 32 GHz). The chip can comprise a processor and/or a machine-readable medium (which can be in operable communication with the processor).

In another embodiment, a method for generating an N-beam TTD beamformer based on sparse factorization of a DVM for a low complexity O(N) algorithm (that is utilized to describe delay and sum operations in a beamformer) can comprise: a) providing the beamformer (which can comprise any or all of the features discussed in the previous paragraph); b) electrically connecting a chip to the plurality of antennas, the plurality of amplifiers, the plurality of filters, and/or the plurality of converters; c) implementing beamforming at baseband and/or an IF lower in frequency than the RF signals, thereby facilitating a scalable beamforming architecture with simplified circuit design, reduced signal processing overhead, and minimized system cost; and d) running an ADVM algorithm on the chip in order to reduce the complexity of the DVM utilized by the beamformer to O(N). The beamformer can be a TTD multibeam beamformer. Step c) can comprise the sub-steps of: performing down-conversion operations of the RF signals to the baseband or the IF, thereby facilitating spatial modulation of matrix elements; mixing the RF signals with cosine and/or sine waves for the baseband, or mixing the RF signals with a sine and/or cosine wave for the IF; and applying the down-conversion operations to both receive-mode systems and transmit-mode systems, thereby enabling a unified architecture that reduces hardware complexity. The method can further comprise: prior to step d), generating a signal flow graph configured to implement an O(N) delay-amplifier algorithm; and modifying the signal flow graph by appending a phase-rotator having a β value to each α delay element value, where each α delay element value corresponds to a delay line (e.g., of the signal flow graph) and each β value corresponds to an amplification (e.g., of the signal flow graph). Step d) can comprise the sub-steps of: generating output beamformed signals by applying the ADVM algorithm at the baseband or at the IF; applying at least one ADFT to implement the ADVM algorithm and/or to perform wideband multibeam beamforming to reduce computational complexity to O(N); and distributing the computations of the at least one ADFT across p parallel processors to reduce the computational complexity to O(N/p), thereby enabling concurrent processing of signal components and improving overall processing efficiency. The beamformer can be configured for wireless systems having fractional bandwidths below approximately 30%, thereby reducing implementation complexity and deployment cost relative to full-bandwidth TTD beamformers (and the method can comprise this configuring of the beamformer). The method can further comprise operating the beamformer in continuous-time and/or discrete-time modes using analog signal processing, digital signal processing, switched-capacitor techniques, and/or switched-current techniques, thereby enabling cost-effective, flexible, and power-efficient implementations. The method can further comprise: mapping the beamformer to custom standard cell libraries; taping out the beamformer by completing a digital IC layout for fabrication; and/or embedding the beamformer in RAN hardware. The beamformer can be configured to be used in (and/or can be applicable to) massive MIMO, 5G, 6G, NextG, FutureG, holographic MIMO, full-duplex, and/or integrated communication and sensing systems. The method can further comprise: implementing the beamformer using analog integrated circuits based on CMOS techniques (e.g., low-cost CMOS techniques) and multiple semiconductor technologies; implementing discrete-time digital processing using circuitry employing at least one of Von Neumann architectures, GPUs, matrix-vector processing methods, tensor cores, systolic arrays, and analog-digital hybrid techniques including compute-in-memory; and/or implementing digital logic on at least one of DSPs, FPGAs, and RF SoC platforms using HDL coding, thereby enabling scalable, energy-efficient, real-time beamforming. The method can further comprise performing sampling using the beamformer, and the beamformer can have a sampling rate as discussed in the previous paragraph.

In another embodiment, a system for generating N-beam TTD beamformers based on sparse factorization of the DVM for low complexity O(N) algorithm (that is utilized by a beamformer to describe delay and sum operations in the beamformer) can comprise: a processor; and a machine-readable medium in operable communication with the processor and having instructions stored thereon that, when executed by the processor, perform the following step: running an ADVM algorithm (e.g., the algorithm shown in FIG. 7 or FIG. 8) in order to reduce the complexity of the DVM algorithm utilized by the beamformer to complexity O(N). The system can further comprise a chip on which the processor and/or the machine-readable medium is disposed. The beamformer can comprise any or all of the features discussed in the paragraph before the previous paragraph. The ADVM algorithm can be implemented using at least one ADFT algorithm. The instructions when executed can further perform the following step: performing sampling using the beamformer (and the beamformer can have a sampling rate as discussed in the paragraph before the previous paragraph).

### BRIEF DESCRIPTION OF DRAWINGS

FIG. 1 shows a delay Vandermonde matrix (DVM) frequency response for N=16 wideband delay-and-sum (DAS) beams. Each beam is fully wideband and squint free. Here, ωₜ=2πf is the temporal frequency, and ωₓ is the normalized spatial frequency. All 16 beams are shown in the same plot. Beam cross sections take the familiar sinc ωₓ form.

FIG. 2 shows an O(N) wideband direct-digital DVM beamformer, according to an embodiment of the subject invention. This particular beamformer is an 8-channel 0 Gigahertz (GHz)-32 GHz O(N) wideband direct-digital DVM beamformer using Intel Altera Agilex 9 Direct-radio frequency (RF) chiplet technology.

FIG. 3 shows a 16-point scaled ADVM algorithm (Asdvm16) representing dashed lines for the multiplication by −1, solid lighter (red) lines for the multiplication by j=\sqrt{−1}, dashed lighter (red) lines for the multiplication by −j,\hat{d}ₖ for the k^{th} component of \hat{D}₁₆, and [symbol] ₖ for the k^{th} component of [symbol] ₃₂, \hat{D}₁₆ and [symbol] ₃₂ are also shown herein.

FIG. 4 shows a table of gain-delay block counts of a scaled ADVM algorithm versus the direct scaled DVM by a vector and O(N log N) DVM algorithm. With respect to the third column, see also Perera et al. (A fast DVM algorithm for wideband time-delay multibeam beamformers, IEEE Transactions on Signal Processing, vol. 70, pp. 5913-5925, 2022; which is hereby incorporated by reference herein in its entirety). The “[6]” at the end of the header for the third column can be ignored.

FIG. 5 shows a table of minimizing the difference between exact and scaled ADVMs through the spectral norm with the best possible α₁, α∈ [symbol] , where α₁=e^{-j(2q+1)π/2} for q∈Z₀⁺. The “9” in the header for the second and fourth columns can be ignored; Equation 6 (as presented herein) is relevant to these columns.

FIG. 6 shows a table of gains, delays, and anti-causal counts of a scaled ADVM algorithm.

FIG. 7 shows a scaled ADVM algorithm, according to an embodiment of the subject invention. It can also be referred to herein as “Asdvm”, “Algorithm 1” or “Algorithm III.1”.

FIG. 8 shows a 16-point ADVM algorithm, according to an embodiment of the subject invention. It can also be referred to herein as “Asdvm16”, “Algorithm 2” or “Algorithm III.2”.

FIG. 9 shows a DVM algorithm, according to an embodiment of the subject invention. It can also be referred to herein as “Algorithm 3” or “Algorithm III.3”.

FIG. 10 shows a DVM algorithm, according to an embodiment of the subject invention. It can also be referred to herein as “Algorithm 4” or “Algorithm III.4”.

FIG. 11 shows two-dimensional spacetime frequency-domain regions of support (ROSs) of 16 true time delay (TTD) wideband bandpass beams as baseband following down-conversion. The RF spectrum is located at approximately 0.7π-π in the normalized temporal circular frequency domain, with 16 unique look directions following the usual DVM structure.

FIG. 12 shows a magnitude response of 16 wideband bandpass beams generated by the DVM beamformer, demonstrating the beam patterns and frequency characteristics across the operational bandwidth.

### DETAILED DESCRIPTION

Embodiments of the subject invention provide novel and advantageous systems and methods for generating N-beam true time delay (TTD) beamformers based on sparse factorization of the delay Vandermonde matrix (DVM) for low complexity O(N) algorithm (e.g., utilized to describe delay and sum operations in beamforming of the beamformer), as well as beamformers utilizing the DVM with a reduced complexity of O(N) (e.g., complexity of no greater than O(N)). The beamformer can be a TTD multibeam beamformer comprising at least one antenna or antenna array (e.g., radio frequency (RF) antenna or antenna array). An approximate DVM (ADVM) algorithm (e.g., an N-point ADVM) can be used that utilizes highly sparse factors, thereby reducing the gain-delay complexity of the DVM-vector product from O(N²) (or in some cases O(N log N)) to O(N).

Crucially, the reduced-complexity ADVM algorithm can be implemented by using an O(N log N) DVM algorithm followed by O(N) approximate discrete Fourier transform (ADFT) algorithms that are applied at low-frequency baseband or intermediate frequency (IF) stages rather than at high-frequency RF. This shift in frequency domain enables simpler, more efficient, and lower-power computation, significantly reducing the gain-delay complexity of the overall DVM algorithm to linear order while avoiding the need for specialized high-speed RF hardware. As a result, embodiments enable practical, scalable beamforming implementations suitable for integration into standard digital processing architectures.

Baseband refers to the original, unmodulated signal occupying the lowest range of frequencies, typically starting from 0 Hz up to the bandwidth of the signal. Baseband represents the signal before modulation onto a higher-frequency carrier. In many systems, especially receivers, signals received at RF are down-converted to either the baseband or the IF to simplify subsequent processing. IF is a frequency band between baseband and RF, created by mixing the incoming RF signal with a local oscillator. The down-conversion retains the key information in the signal while shifting it to a frequency range that is easier to process.

Processing at baseband or IF offers significant advantages over direct high-frequency RF processing. Both operate at lower frequencies, enabling the use of simpler, lower-power, and cost-effective circuits. Baseband or IF implementations supports integration with complementary metal-oxide-semiconductor (CMOS)-compatible technologies, reducing system cost and complexity. While IF signals are not as low-frequency as baseband, the IF signals still preserve modulation and spectral characteristics and avoid the high losses and stringent component requirements typical of RF, especially at millimeter wave (mmWave) and terahertz (THz) frequencies. RF processing demands power-hungry, high-precision components that suffer from increased signal degradation, electromagnetic losses, and fabrication challenges. In contrast, baseband or IF processing enables improved signal integrity, reduced power consumption, and easier hardware integration.

These advantages make baseband and IF domains ideal for implementing complex multibeam beamforming techniques, such as ADFT-based beamformers, in scalable and commercially viable wireless and radar systems. By utilizing lower frequency technology, baseband/IF implementations simplify the design and reduce power consumption for both digital and analog beamformers. The baseband or IF implementation also eliminates the need for special semiconductor technologies required for extremely high RF bands exceeding 100 GHz, including sub-THz frequencies, making real-world wideband multibeam systems significantly cheaper, easier to implement, and more scalable than custom RF integrated circuits.

A bandpass signal occupies the frequency range defined by f_{L}<f<f_{H} at RF with a center frequency

$${f}_{c} = \frac{{f}_{L} + {f}_{H}}{2} .$$

The RF signal is denoted as x_{R}(t). For the purpose of illustrating the underlying concept, the case of receiver-mode beamforming is first considered. The RF signal x_{R}(t) can be down-converted to an IF by mixing with a sinusoidal wave cos (2πf_{L}t) resulting in

$${x}_{I F} ( t ) = {x}_{R} ( t ) cos ( 2 π {f}_{L} t ) .$$

Subsequent conversion to baseband is performed by mixing x_{R}(f) with a cosine wave of frequency f_{c} such that the center frequency of the spectrum of x_{R}(t) is shifted to direct current (DC).

Next, an RF plane wave propagates at an angle ψ, measured counterclockwise from the broadside direction of a uniform linear array (ULA). Such a wave can be represented as a two-dimensional (2D) spacetime signal

$${w}_{R} ( x / c , t ) = {x}_{R} ( - ( x sin ψ ) / c + t ) ,$$

which occupies the temporal bandwidth f_{L}<f<f_{H}, consistent with the earlier one-dimensional (1D) example.

The 2D spectrum of this wave is defined as the 2D complex Fourier transform function containing spatiotemporal frequencies (fₓ, f)∈ [symbol] ², denoted as X_{R}(fₓ, f). The spectrum occupies a beam-shaped region in the 2D spatiotemporal frequency domain.

Applying temporal down-conversion to this 2D wave corresponds to a frequency translation operation as dictated by the modulation property of the Fourier transform. Specifically, the multiplication

$${x}_{R} ( x / c , t ) cos ( j 2 π {f}_{c} t )$$

generates two spectral copies, translated respectively to DC and 2f_{c}. The original beam-shaped spectral region in the 2D spatiotemporal domain, located at

$${f}_{x} = f sin ψ ,$$

is shifted such that, ignoring the high-frequency image, the baseband signal spectrum is centered at DC and expressed as

$${X}_{R} ( {f}_{x} , f - {f}_{c} ) .$$

The region of support (ROS) of the down-converted 2D signal remains beam-shaped and oriented identically to the original RF wave but is relocated to DC in the temporal frequency axis. The DC frequency point corresponds to the spatial frequency fₓ.

The bandwidth of the wave is

$$B = {f}_{H} - {f}_{L} ,$$

and the fractional bandwidth u is defined as

$$μ = B / {f}_{c} .$$

For example, the S-band frequency range defined between 2 GHz and 4 GHz leads to

$${f}_{c} = 3 GHz , B = 2 GHz , and μ = 2 / 3.$$

A ULA consists of N radiating elements with inter-element spacing Δx less than or equal to the wavelength λ_{H} at the highest frequency of interest f_{H}. Given the propagation speed of electromagnetic waves as c, the corresponding inter-element propagation delay is

$$τ = Δ x / c .$$

Assuming the array comprises N antenna elements, the generation of N TTD beams can be realized by selecting a unit delay of duration

$$τ 0 = τ / N ,$$

where the said N beams are realized by an N×N matrix of true time delays known as the DVM.

In one approach, the N multi-beams generated by the TTD beamformer fully cover the bandwidth of any wideband signal within the frequency range of interest. However, such a TTD beamformer requires N² TTD elements in total.

A new complexity metric, termed “delay complexity,” analogous to arithmetic complexity in digital signal processing, is defined for analog implementations of the DVM. The delay-amplifier complexity for a conventional DVM implementation is O(N²), based on the assumption that each beam requires N amplification stages and N TTD units.

The delay-amplifier complexity is reduced from O(N²) to O(N log N), analogous to fast Fourier transform (FFT) arithmetic complexity. Further reduction to linear order, O(N), was achieved through approximate computing techniques known in the literature. This ADFT computation permits complexity reduction at the cost of a minor beam fidelity degradation, quantified as a sidelobe level loss of less than approximately 2 decibels (dB).

While the aforementioned approach supports full-bandwidth operation suitable for wideband applications such as military communication, signals intelligence, and radio astronomy, it is recognized that commercial wireless communication networks, including fourth-generation Long Term Evolution (4G LTE), fifth-generation New Radio (5G NR), and forthcoming sixth-generation (6G) and Next Generation (NextG) systems, exhibit bandpass signal characteristics with significantly narrower fractional bandwidths.

For instance, emerging wireless systems such as Wireless Fidelity (Wi-Fi) and 6G may operate in the 7 to 8 gigahertz (GHz) band, which corresponds to the upper mid-band or Frequency Range 3 (FR3) spectrum, supporting bandwidths approaching 1 GHz. Conventional phased-array beamformers fail to maintain squint-free beamforming across such bandwidths, necessitating the use of TTD beamforming.

However, fully specified TTD beamformers developed previously, designed to accommodate 100% fractional bandwidth, are considered over-specified for these commercial scenarios, where fractional bandwidths are typically less than 30%. Embodiments of the subject invention aim to develop novel multibeam TTD algorithms that optimize performance and reduce deployment costs by exploiting the lower fractional bandwidths prevalent in commercial wireless applications.

The parent application (U.S. patent application Ser. No. 19/095,898) employs a TTD multibeam beamformer over an N-element ULA to produce N TTD wideband beams. The DVM assumes the form of an N×N square matrix, whose (k, l)-element is given by α^{kl}, where α=e^{-jωτ}^{₀}, ω denotes the temporal frequency, t represents the delay, and indices k, l=0, 1, . . . , N−1. Here, k corresponds to the row index, and/corresponds to the column index of the matrix. Alternatively, α can be expressed as α=e^{-2πτ}^{₀}, where τ₀=τ/N and τ=Δx/c, with Δx as the inter-element spacing and c as the speed of wave propagation.

To realize a DVM matrix operating at baseband or IF domains, as defined by the down-conversion operations, spatial modulation of matrix elements is employed. This modulation induces the necessary spectral shifts along the spatial frequency axis, ensuring that each passband of the multibeam TTD transfer function aligns centrally with the spectrum of the down-converted signals received from the ULA.

Invoking the modulation property of the DFT, a complex modulation constant β=e^{-jπ/N} is introduced and applied multiplicatively to each α^{kl} element, thereby modifying the (k, l)-th coefficient γ^{kl}=(αβ)^{kl}.

It is important to note that, in practical circuit implementations, the quantities α and β correspond to physically distinct components: α values are realized as delay lines, whereas β values represent amplifier phase rotators. Consequently, the product αβ cannot be merged into a single element but must be implemented as a delay element followed by a complex gain and phase shift.

Practically, the system begins with an optimal signal flow graph representation of the multibeam DVM factorization minimizing delay elements (i.e., the lowest achievable count of a values), corresponding to an O(N) delay-amplifier complexity algorithm previously demonstrated.

To enable baseband or IF domain realization, the signal flow graph of this O(N) delay-amplifier algorithm is modified by appending a phase rotator with value β to each delay element α. Thus, for k delay units, the system realizes a composite element α^{k}β^{k}, consisting of k delay units each with duration τ₀, followed by phase rotation corresponding to β^{k}.

With the utilization of the modulation property of the DFT and the DVM antenna network A_{N} disclosed in the parent application, a matrix B_{N}=C_{N}ºA_{N} can be mathematically constructed to operate at baseband or IF using the down-conversion operations described herein, where denotes the Hadamard product. Here,

$${C}_{N} = {[ {e}^{- j π k l / N} ]}_{k , l = 0}^{N - 1} \\ and \\ {A}_{N} = {[ {α}^{k l} ]}_{k = 1 , l = 0}^{N , N - 1} .$$

Although, B_{N} is represented as the Hadamard product of C_{N} and A_{N}, due to the structural properties of these matrices, B_{N} may be viewed as a modified DVM wherein the delays in the (k, l)-th coefficient of the DVM, i.e., α^{kl}, are replaced by γ^{kl}:=(αβ)^{kl}. Accordingly, the modified DVM can be expressed as

$${B}_{N} = {[ {γ}^{k l} ]}_{k = 1 , l = 0}^{N , N - 1} .$$

This formulation demonstrates that the delays α in the DVM can be physically realized through both delay elements and amplifiers β. This approach significantly reduces computational complexity compared to the straightforward Hadamard product implementation, which exhibits O(N²) complexity.

The down-conversion operations can be implemented in both receive-mode and transmit-mode systems, thereby facilitating a unified system architecture that reduces overall hardware complexity and promotes design efficiency. The down-converted signals is denoted by xₖ(t), k=0, 1, . . . , N−1 for an N-element array. For example, when N=16, k=0, 1, . . . , 15. The input vector is defined as x̅=[x₀(t)x₁(t) . . . x_{N-1}(t)]^{T}. The output vector y̅=[y₀(t) y₁(t) . . . y_{N-1}(t)]^{T} is computed by the matrix multiplication y̅=B_{N}x̅, where

$${B}_{N} = {[ {γ}^{k l} ]}_{k = 1 , l = 0}^{N , N - 1}$$

is the modified DVM matrix adopted for the wideband bandpass case.

Utilizing the factorization of the DVM, the factorization for the modified DVM can be expressed as:

$${B}_{N} = {{\hat{D}}_{N}^{{}_{( γ )}} [ {J}_{M \times N} ]}^{T} {F}_{M}^{*} {{D}^{⌣}}_{M}^{{}_{( γ )}} {F}_{M} {J}_{M \times N} {{D}^{⌣}}_{N}^{{}_{( γ )}} {D}_{N}^{( γ )} , where \\ γ = α β , M = 2 N , {J}_{M \times N} = [ \frac{{I}_{N}}{{0}_{n}} ]$$

is a sparse matrix consisting of an identity matrix IN and a zero matrix ON, and the diagonal matrices are defined as:

$${D}_{N}^{( γ )} = {diag [ {γ}^{k} ]}_{k = 0}^{N - 1} , {\hat{D}}_{N}^{{}_{( γ )}} = {diag [ {γ}^{\frac{{k}^{2}}{2}} ]}_{k = 0}^{N - 1} , \\ and \\ {{D}^{⌣}}_{M}^{{}_{( γ )}} = diag [ {\tilde{F}}_{M} {c}^{{}_{( γ )}} ] .$$

C_{M} is a circulant matrix defined by its first column c^{(γ)} given as:

$${c}^{( γ )} = {[ 1 , {γ}^{- \frac{1}{2}} , … , {γ}^{- \frac{{( N - 1 )}^{2}}{2}} , 1 , {γ}^{- \frac{{( N - 1 )}^{2}}{2}} , {γ}^{- \frac{{( N - 1 )}^{2}}{2}} , … , {γ}^{- \frac{1}{2}} ]}^{T} ,$$

where T denotes the transpose operation.
The DFT matrix is defined as

$${F}_{N} = {\frac{1}{\sqrt{N}} [ {w}_{N}^{k l} ]}_{k , l = 0}^{N - 1} \\ and \\ {w}_{N} = {e}^{- \frac{2 π j}{N}} ,$$

and the scanned Fourier transform matrix is

$${\tilde{F}}_{N} = \sqrt{N} {F}_{N} .$$

Thus, the beamformed output signals y̅ for the down-converted input signals x̅ can be computed as described above.

Proposition 1.1: Let the scanned modified

$$DVM {\tilde{B}}_{N} = {[ {γ}^{kl} ]}_{k , l = 0}^{N - 1}$$

be defined by notes {1, γ, γ², . . . , γ^{N-1}}∈ [symbol] , with N=2^{r}, r≥1, and M=2N. Then, for the given down-converted input signals x̅, the wideband multibeam beamformed signal can be computed as

$$\overline{y} = {\tilde{B}}_{N} \overline{x} = {{\hat{D}}_{N}^{( γ )} [ {J}_{M \times N} ]}^{T} {F}_{M}^{*} {\breve{D}}_{M}^{( γ )} {F}_{M} {J}_{M \times N} {\hat{D}}_{N}^{( γ )} \overline{x} .$$

Proof. This follows by substituting the α values with γ=αβ, thus enabling physical realization of α values as delay lines, and β values as amplifiers.

Building on Proposition 1.1, the arithmetic complexity of realizing wideband multibeam beamformers corresponding to the modified scaled DVM (MSDVM) is analyzed. The number of additions and multiplications are required to compute y=\tilde{F}_{N}z, where z= [symbol] ^{N}, be Nr and

$$\frac{1}{2} Nr - \frac{3}{2} N + 2 ,$$

respectively (excluding multiplication by ±1 and ±j), based on the FFT algorithm. The number of additions #a and the number of multiplications #m, corresponding to adders and amplifier-delay blocks, for realizing the beamformed signals y via the scaled modified DVM sMdvm are given as follows.

Proposition 1.2: Let N=2^{r}, r≥1. Then, the beamformed signals y̅ for the scaled modified DVM applied to the down-converted input signals x̅ can be computed with arithmetic complexities:

$$\# a ( sMdvm , N ) = 4 Nr + N and$$

$$\# m ( sMdvm , N ) = 2 Nr + 2.$$

Proof. This complexity calculation follows the same lines as Lemma III.I in IEEE Transactions on Signal Processing, vol. 70, pp. 5913-5925, 2022.

Proposition 1.2 establishes that realizing wideband multibeam beamformers using the modified scaled DVM requires computational complexity of order O(N log N), representing a significant improvement over the naive O(N²) complexity. To further reduce complexity to linear order, the technique is applied wherein the DFT matrix is replaced by an ADFT, leading to the following result.

Proposition 1.3: Let the scaled modified DVM

$${\tilde{B}}_{N} = {[ {γ}^{kl} ]}_{k , l = 0}^{N - 1} ,$$

with nodes {1, γ, γ², . . . , γ^{N-1}}∈ [symbol] , (r≥4), and M=2N. Then, wideband multibeam beamformers can be realized with an approximation by an N-point scaled modified DVM \hat{B}_{N}, such that for down-converted input signals x̅,

$$\overline{y} \approx {\hat{B}}_{N} \overline{x} = {{\hat{D}}_{N}^{( γ )} [ {J}_{M \times N} ]}^{T} {\hat{F}}_{M}^{*} {\breve{D}}_{M}^{( γ )} {\hat{F}}_{M} {J}_{M \times N} {\hat{D}}_{N}^{( γ )} \overline{x} ,$$

where \hat{F}_{M} denotes an ADFT matrix.

Proof. This factorization is obtained by substituting F_{M} and

$${F}_{M}^{*}$$

in Proposition 1.1 with the ADFT matrices \hat{F}_{M} and

$${\hat{F}}_{M}^{*} .$$

By applying the ADFT methods, the arithmetic complexity for realizing wideband multibeam beamformers using scaled modified ADVMs with points 8, 16, 32, and 64 can be calculated as 4N-2, 4N-2, 6N-6, and 10N-30, respectively.

In summary, replacing the FFT with ADFT in the realization of wideband multibeam beamformers reduces complexity from O(N²) to O(N) for a relatively small number of beams. This result can be generalized as follows.

Proposition 1.4: Wideband multibeam beamformers y realized using the approximation \hat{B}_{N} for the N-point scaled modified DVM and down-converted input signals x̅, with the ADFT having multiplication complexity O(N), incur amplifier-delay implementation complexity reduced to O(N), compared to the prior O(N²) complexity. Moreover, when employing p parallel processors, the complexity further decreases to O(N/p).

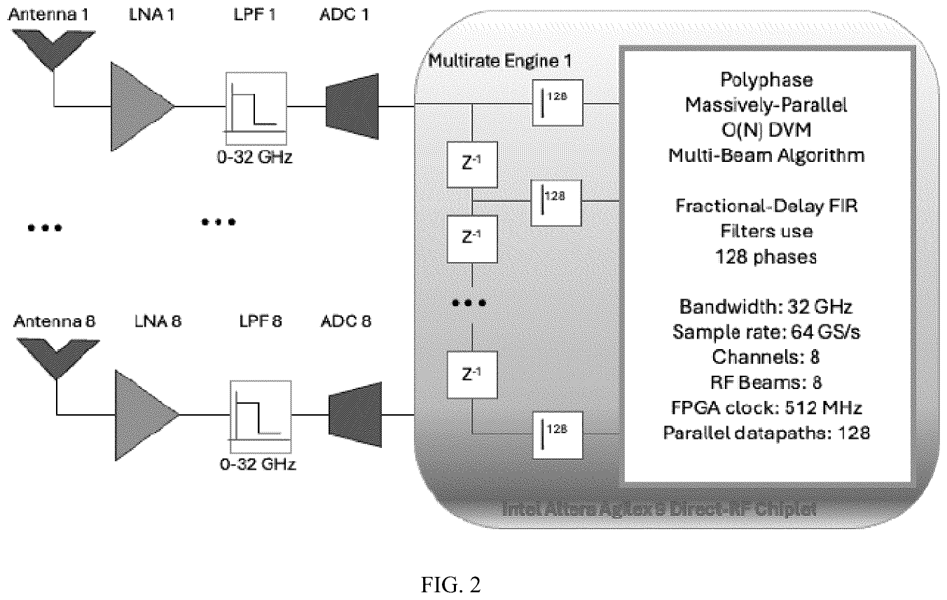

In the example in FIG. 2, the parameter k is selected as 0.5. In the fast factored implementation of the disclosed wideband bandpass DVM, each delay term α^{l} in the original DVM fast factorization is replaced by delay-phase-shifter term given by

$${α}^{l} {e}^{- j π / N ( l {τ}_{0} / K )} ,$$

where K is a constant determined by the degree of down-conversion and fractional bandwidth of the signals. There are N distinct paths with varying phasing and delays in the fast algorithms, for l=0, 1, . . . , N−1. In the example, K=4.

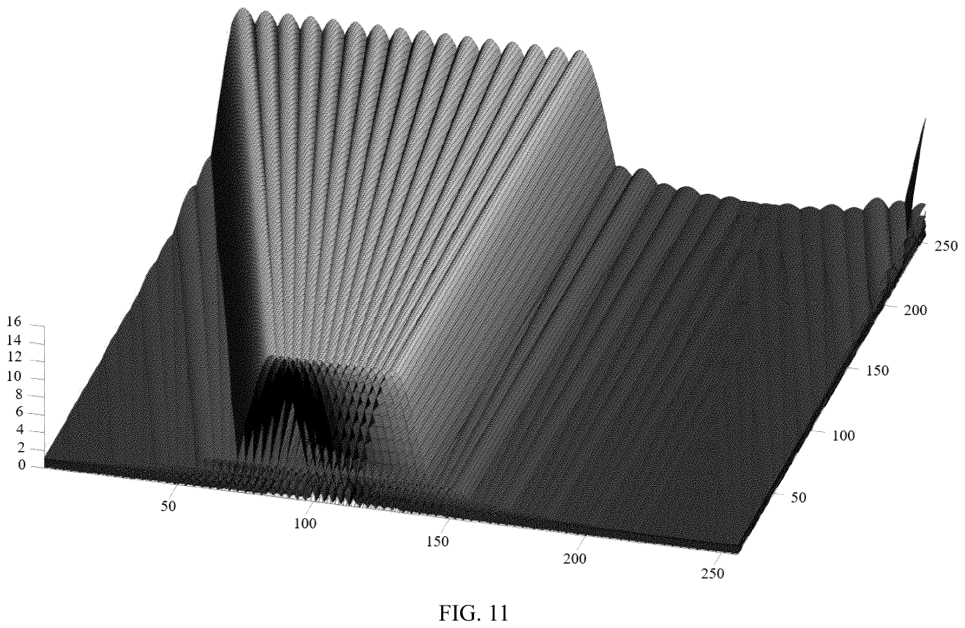

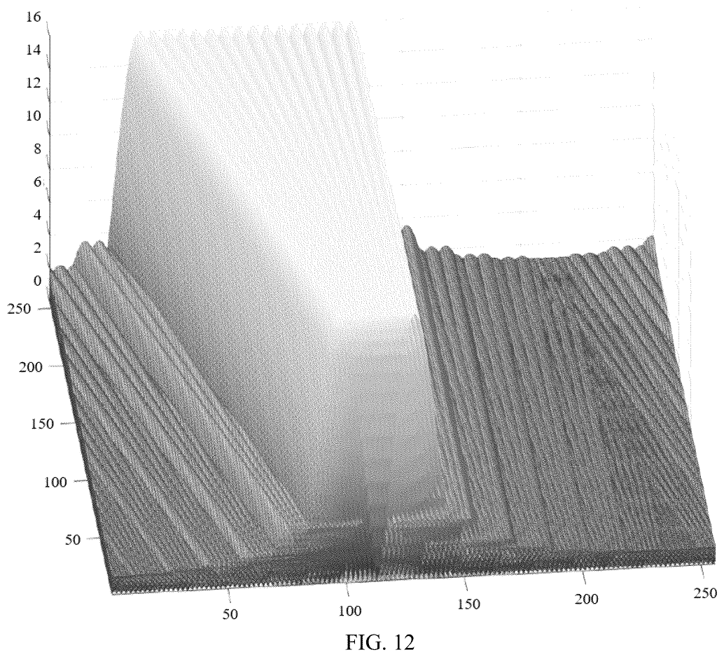

FIG. 11 shows 2D spacetime frequency-domain ROSs of 16 TTD wideband bandpass beams as baseband following down-conversion. The RF spectrum is located at approximately 0.7π-π in the normalized temporal circular frequency domain, with 16 unique look directions following the usual DVM structure. FIG. 12 shows a magnitude response of 16 wideband bandpass beams generated by the DVM beamformer, demonstrating the beam patterns and frequency characteristics across the operational bandwidth.

Modern communication systems increasingly demand wider bandwidths. However, conventional TTD multibeam beamformers are often over-designed for commercial wireless applications. For typical fractional bandwidths in the range of approximately 10-30%, TTD techniques remain applicable but are more efficiently realized at baseband or IF rather than at RF. The disclosed DVM, along with its factorization and associated architecture, enables the realization of TTD multibeam systems for wideband bandpass signals in a practical and scalable manner.

The disclosed wideband bandpass TTD DVM algorithm supports implementations at baseband or IF, which has significant implications for hardware design and system cost. Operating at lower frequencies than traditional wideband TTD systems allows the use of low-cost components with improved specifications, greater availability, and reduced reliance on exotic wideband materials or devices.

Moreover, the algorithm scales efficiently with system size. When realized, the disclosed method supports linear scalability, with circuit complexity scaling as O(N), enabling practical deployment in systems with large numbers of elements. This leads to reduced chip area, lower circuit complexity, decreased power consumption, and smaller size and weight compared to conventional TTD-based beamforming systems.

Notably, the disclosed wideband bandpass TTD DVM algorithm requires only O(N) TTD elements to generate N beams, offering substantial improvements in efficiency and implementability over prior art.

The disclosed wideband bandpass TTD DVM algorithm can be implemented using analog integrated circuits fabricated with multiple types of semiconductor technologies and across various process nodes. Example technologies include gallium arsenide (GaAs), indium phosphide (InP), silicon germanium, complementary metal-oxide-semiconductor (CMOS), bipolar and bipolar-complementary metal-oxide-semiconductor (BiCMOS) technologies, as well as emerging platforms such as gallium nitride (GaN).

The disclosed algorithm can be realized in either continuous-time or discrete-time modes, employing continuous-time analog techniques, continuous-time digital signal processing, switched-capacitor methods, switched-current techniques, or any combination thereof.

In addition, the disclosed wideband bandpass TTD DVM algorithm may be implemented using discrete-time digital processing methods based on conventional computer arithmetic and computer architecture, including Von Neumann architectures, graphics processing units (GPUs), matrix-vector processing techniques, tensor cores, systolic array architectures, and emerging analog-digital hybrid approaches such as compute-in-memory.

The disclosed wideband bandpass TTD algorithm can be implemented using digital signal processing techniques, including deployment on commercially available digital signal processor (DSP) devices or chips. Additionally, the algorithm may be realized using field-programmable gate array (FPGA) platforms and radio frequency system-on-chip (RF SoC) technology through hardware description language (HDL) coding.

The system can be synthesized using custom standard cell libraries and implemented through a completed digital integrated circuit (IC) layout, enabling tape-out for semiconductor fabrication. Alternatively, it may be embedded as a subsystem within radio access network (RAN) hardware front-end architectures.

Use cases of the disclosed wideband bandpass TTD algorithm include massive multiple-input multiple-output (MIMO) radio systems, 5G, 6G, Next Generation (NextG), and Future Generation (FutureG) wireless communication systems. Additional applications include holographic MIMO systems, full-duplex transceiver architectures, and integrated communication and sensing platforms.

Unlike RF beamforming, which operates directly at the carrier frequency, baseband or IF beamforming occurs at substantially lower frequencies. This enables the use of cost-effective components and simplifies overall system design. However, beamforming algorithms must be appropriately adapted to operate efficiently within the baseband or IF domains. In this disclosure, the TTD DVM wideband multibeam beamforming algorithm has been extended from RF operation to baseband or IF domains. The resulting modified algorithm produces a multibeam signal flow graph architecture that is suitable for implementation using both analog and digital circuit techniques.

Recent advances in beamforming techniques and integrated circuit (IC) technology have led to the development of high-bandwidth active beamforming systems. These systems are becoming increasingly attractive alternatives, especially in 5G/6G systems that aim to maximize the available bandwidth of up to 300 GHz to enhance system capacity. To achieve this, TTD-based multibeam beamformers are crucial, and these can be mathematically modeled using a DVM multibeam algorithm. DVM beamformers are based on TTD approaches and thus are squint-free and wideband in frequency response. However, DFT beamformers are narrow-band and suffer from beam squint as a function of temporal frequency. To wit, DVM beamformers are needed for emerging wideband systems, while legacy systems that are relatively narrowband in temporal frequency response can use DFT beamformers via FFT algorithms. As wideband systems that operate over extreme frequency ranges become more prevalent, DVM beamformers will be needed as DFT/FFT beamformers suffer from the beam squint (frequency dependence in beam direction) problem.

The TTD multibeam beamformer has extensive applications in wireless communications and RF sensing. Related art TTD multibeam beamformers have circuit complexity that grows as O(N²) for N beams for N-element antenna arrays. Embodiments of the subject invention can reduce it to O(N) (i.e., such that the TTD multibeam beamformer has circuit complexity that grows as O(N)). The circuit and computational complexity reduction of TTD multibeam RF antenna array beamformers from quadratic O(N²) to linear O(N) have extensive applications for low power, low complexity RF and wireless systems for commercial wireless, defense, imaging, and scientific markets.

DFT beamformers are realized using FFT algorithms. Variants of the Cooley-Tukey FFT algorithm are widely acclaimed for its effectiveness in handling band-limited and sample discrete-domain signals via efficient computation of DFTs. The Cooley-Tukey FFT algorithm significantly diminishes multiplicative complexity, allowing for enhanced computation speed. FFT applications encompass such areas as artificial intelligence (AI)/machine learning (ML) computations and beamforming in radar and mm Wave wireless network systems. In contrast, the ADFT reduces the multiplicative complexity while preserving its final additive complexity at O(N log N). This makes ADFT algorithms well-suited for applications in narrowband and wideband beamforming. By employing ADFTs instead of FFTs, these networks can possibly reduce the required computational operations, which in turn helps reduce overall circuit complexity, chip area, and power consumption. The ADFT block contains a certain amount of computational error that prevents or inhibits it from producing an exact DFT. Nevertheless, the radio/wireless multibeam beamforming applications of the majority of ADFT algorithms can tolerate these small beam errors without significantly affecting performance. For instance, ADFT beamformers have worst-case sidelobe levels degraded by about 1.5 dB to about 2 dB compared to DFT beamformers.

As the size of the matrices increases, the DVM algorithm requires nearly 60% fewer addition and multiplication counts compared to other beamforming techniques, such as brute-force matrix-vector computation (see also, Perera et al., Wideband n-beam arrays with low-complexity algorithms and mixed-signal integrated circuits, IEEE Journal of Selected Topics in Signal Processing, vol. 12, no. 2, pp. 368-382, 2018; which is hereby incorporated herein by reference in its entirety). The DVM is a superclass of the DFT matrices, and it lacks periodic and unitary properties. Nevertheless, stable and O(N log N) DVM algorithms can be used for narrowband multibeam beamforming. Also, the nodes of the Vandermonde matrices can be a special case (i.e., complex nodes can be equally spaced on the unit circle (not necessarily the primitive roots of unity) and any other circle having a radius more than the unity). An O(N log N) DVM algorithm can enable truly wideband multibeam beamforming (see also Perera et al., A fast dvm algorithm for wideband time-delay multibeam beamformers, IEEE Transactions on Signal Processing, vol. 70, pp. 5913-5925, 2022; which is hereby incorporated by reference herein in its entirety, and which is also cited in the Brief Description of the Drawings). Embodiments of the subject invention provide a way to get the DVM algorithm complexity down to O(N), which can include computations via approximate computation methods that replace O(N log N) FFTs with factorized ADFTs that are O(N).

Formation of N simultaneous true-time delay-and-sum (DAS) RF beams from an N-element array of wideband antennas has many applications in wireless communications, electronic warfare, spectrum sensing, radar, and signals intelligence. A conventional DAS wideband beamformer scales as O(N²) different individual delay line segments (i.e., the delay complexity), which makes large arrays with many antennas and wideband beams impractical. Embodiments of the subject invention provide systems and methods based on the factorization of the ADFT matrix that reduces the delay complexity from O(N²) to O(N), which in turn makes dense aperture antenna arrays with large N elements lead to N number of DAS beams at significantly smaller delay line count. Each delay can be realized in a digital signal processor (DSP) as a finite impulse response (FIR) filter. Therefore, a wideband N-beam system at O(N) delay line complexity as opposed to O(N²) leads to a significant reduction and hence a smaller chip area and power consumption for hardware realization on a digital chip (e.g., an application specific integrated circuit (ASIC) chip). In an embodiment, an 8-beam DAS digital multibeam beamformer using state-of-the-art (SOTA) Agilex-9 Direct-RF chiplets from Intel can support sample rates up to 64 Giga samples per second (GS/s) per channel.

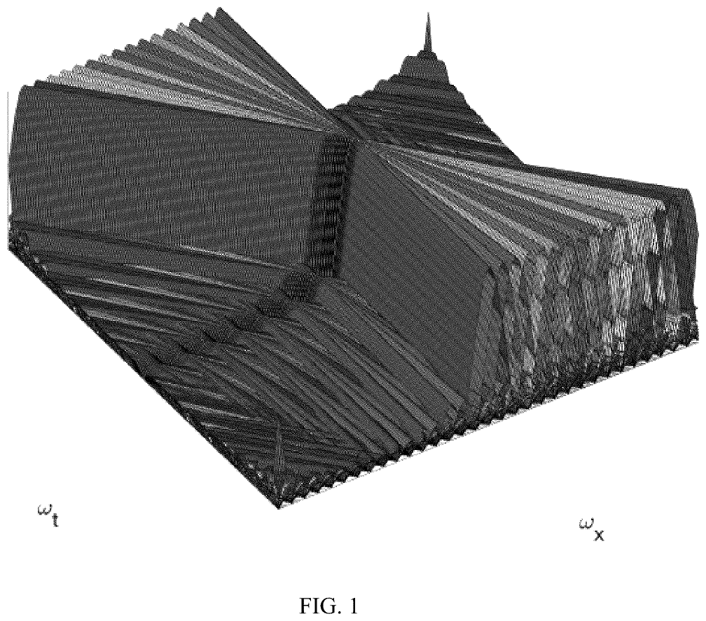

The N×N DVM N-beam beamformer is a special case of beamformer where each p=1, 2, . . . , N beam is realized by integer multiple delays of τₚ=pτ/N². The frequency responses (beam shapes) of the DVM for N=16 beams are shown in FIG. 1. The straightforward realization of N-beams using the DVM-vector operation leads to a parallel hardware realization that essentially uses N² delays. The circuit complexity associated with this multibeam receiver/transmitter thus scales as O(N²); such a “quadratic complexity” makes scaling to a large number of beams from a high valued N (dense aperture arrays) extremely challenging. To address this problem, a new class of DVM beamforming algorithms can factor the matrix-vector product into a sequence of sparse matrices-vector products so that the net number of delays is reduced to O(N log N), where N=2^{r} (r≥2); this is the same

$$\frac{log N}{N}$$

factor or reduction, albeit for the number of delays just like for the case of applying FFTs in place of direct matrix-vector operations when one is computing a DFT. FFTs exhibit butterfly networks in their signal flow graph representations (see also Perera et al., 2022, supra.).

Embodiments of the subject invention provide DVM wide-band multibeam beamforming algorithms that achieve N-wideband beams at linear complexity; that is, the DVM beamformer requires only O(N) delays to realize N-beams. The realized beams are within about 2 dB of the ideal DVM beams in their directional selectivity. This massive reduction can be achieved by starting from the O(N log N) DVM multibeam algorithm that makes use of the exact DFT (see also Perera et al., 2022, supra. (cited in the previous paragraph)). The DVM in Perera et al., 2022 (supra.) can be replaced with an ADFT instead (see also; Madanayake et al., Design of multichannel spectrum intelligence systems using ADFT algorithm for antenna array-based spectrum perception applications, Algorithms, vol. 17, no. 8, 2024, mdpi.com/1999-4893/17/8/338; Cintra et al., Fast radix-32 ADFT for 1024-beam digital RF beamforming, IEEE Access, vol. 8, pp. 96 613-96 627, 2020; and Ariyarathna et al., Towards a low-swap 1024-beam digital array: A 32-beam subsystem at 5.8 GHz, IEEE Transactions on Antennas and Propagation, vol. 68, no. 2, pp. 900-912, 2020; all three of which are hereby incorporated by reference herein in their entireties). An exact DFT can be realized at O(N log N) via FFTs while the ADFT has a corresponding matrix sparse factorization that exhibits O(N) delays in DVM aggregated across its butterfly networks. Therefore, even though there is a small (1.5 dB or less) loss of directional selectivity, a massive reduction in the number of TTD circuits can be achieved while still obtaining N-simultaneous beams.

The DVM can be explicitly defined by

$${A}_{N} := {[ {A}_{kl} ]}_{N} = {[ {α}^{kl} ]}_{k = 1 , l = 0}^{N , N - 1} ,$$

where N=2^{r} (r≥1), {α, α², . . . , α^{N}} are distinct complex nodes s.t. α=e^{-jωτ}, j²=−1, 0 is the temporal frequency, and t is the delay (see also; Perera et al., Wideband n-beam arrays with low-complexity algorithms and mixed-signal integrated circuits, IEEE Journal of Selected Topics in Signal Processing, vol. 12, no. 2, pp. 368-382, 2018; Perera, Madanayake, and Cintra, Efficient and self-recursive delay Vandermonde algorithm for multibeam antenna arrays, IEEE Open Journal of Signal Processing, vol. 1, no. 1, pp. 64-76, 2020; and Perera, Madanayake, and Cintra, Radix-2 Self-recursive Algorithms for Vandermonde-type Matrices and True-time-delay Multibeam Antenna Arrays, IEEE Access, vol. 8, pp. 25498-25508, 2020; all three of which are hereby incorporated by reference herein in their entireties). The scaled DVM (i.e., scaling with respect to a diagonal matrix) is defined as

$${\tilde{A}}_{N} := {[ {\tilde{A}}_{kl} ]}_{N} = {[ {α}^{kl} ]}_{k = 1 , l = 0}^{N , N - 1} .$$

The coefficient α^{kl} is a temporal Fourier transform of a pure time-delay of duration τ. The signal x(t) with Fourier transform X(ω) is related to the delayed version of the signal x(t−pτ) via the relationship X(ω)e^{-jpωτ}. Thus, the corresponding phase rotation of X(ω) is simply α^{p}=e^{-jpωτ}. Crucially, the DVM contains closed-form complex functions of @ given as complex phase rotations in integer powers p of α. That is, α^{p} are not numerical values; they are complex functions of frequency ω raised to power p. Hence, an N× N DVM containing powers of a looks like a matrix-vector product, but this is in the temporal Fourier domain, so this is defined O(N²) number of delay-and-sum dot product, not the usual O(N²) number of multiply-and-sum dot product.

Mathematical techniques exist to derive radix-2 and split-radix FFT algorithms (see also; Cooley and Tukey, An algorithm for the machine calculation of complex Fourier series,” Math. Comp., vol. 19, pp. 297-301, 1965; Yavne, An economical method for calculating the discrete fourier transform, in in Proc. AFIPS Fall Joint Computer Conf. 33, 1968, pp. 115-125; Strang, Introduction to Applied Mathematics, USA: Wesley-Cambridge Press, 1986; Loan, Computational Frameworks for the Fast Fourier Transform, Philadelphia, USA: SIAM Publications, 1992; Johnson et al., A modified split-radix FFT with fewer arithmetic operations,” IEEE Trans., vol. 55, no. 1, p. 111-119, 2007; Rao et al., Fast Fourier Transform: Algorithm and Applications. New York, USA: Springer, 2010; and Blahut, Fast Algorithms for Signal Processing, Cambridge University Press, 2010, api.semanticscholar.org/CorpusID:53846853; all seven of which are hereby incorporated by reference herein in their entireties; see also Perera et al., 2022, supra.). Even though the derivation of size-N DFT into two size-N DFTs can be done easily, the extension of this idea to the DVM is cumbersome because the useful DFT matrix properties, like periodicity and unitary, are not present in the DVM. Consequently, considering these mathematical properties and the representation of DVM elements through TTD wideband multibeam, unlike the narrowband representation characterized by the FFT-beams, it becomes evident that DVM serves as a superclass of DFT matrices.

Various DVM algorithms can be designed to accurately compute the exact DVM-vector product for both narrowband and wideband communication systems. Perera et al., 2022 (supra.) presents a derivation of the DVM algorithm, successfully reducing the complexity of RF N-beam analog beamforming systems from O(N²) to O(N log N). While some DVM algorithms show greater efficiency compared to brute-force matrix-vector calculations, their arithmetic complexity remains substantially higher than O(N log N). On the other hand, numerically stable DVM algorithms with complexity of O(N log N) apply to Vandermonde matrices with nodes positioned on the unit circle (not exclusively at the roots of unity) and also on circles with their center at the origin and a radius exceeding one (see also, Perera, Madanayake, and Cintra, Radix-2 Self-recursive Algorithms for Vandermonde-type Matrices and True-Time-Delay Multibeam Antenna Arrays, IEEE Access 8, 2020). Unlike some DVM algorithms that are specifically designed for narrowband communication systems, the radix-2 DVM algorithm is tailored for TTD wideband communication systems.

Embodiments of the subject invention can use sparse factors to compute an ADVM using a 16-point DVM followed by ADFT to reduce delay complexity from quadratic to linear. Before stating the factorization formula for the ADVM, the factorization leading O(N log N) DVM algorithm will be discussed.

The scaled DVM factorization resulting in an O(N log N) DVM algorithm executes based on the DVM factorization defined below (see also Perera et al., 2022, supra.)

$${\tilde{A}}_{N} = {{\hat{D}}_{N} [ {J}_{M \times N} ]}^{T} {F}_{M}^{*} {\breve{D}}_{M} {F}_{M} {J}_{M \times N} {\hat{D}}_{N} ,$$

$$where M = 2 N , {J}_{M \times N} = [ \frac{{I}_{N}}{{0}_{N}} ]$$

is a highly sparse matrix containing the identity matrix IN and the zero matrix ON, T denotes the transpose of matrices. The matrices

$${D}_{N} = {diag [ {α}^{k} ]}_{k = 0}^{N - 1} , {\hat{D}}_{N} = {diag [ {α}^{\frac{{k}^{2}}{2}} ]}_{k = 0}^{N - 1} and {\breve{D}}_{M} = diag [ {\tilde{F}}_{M} c ]$$

and diagonal matrices, and a circulant;

$${C}_{M} := {F}_{M}^{*} {{D}^{︶}}_{M} {F}_{M} ,$$

which is defined by the first column

$$c s . t . c = {[ 1 , {α}^{- \frac{1}{2}} , … , {α}^{- \frac{{( N - 1 )}^{2}}{2}} , 1 , {α}^{- \frac{{( N - 2 )}^{2}}{2}} , … , {α}^{- \frac{1}{2}} ]}^{T} .$$

The DFT matrix is defined by

$${F}_{N} = {\frac{1}{\sqrt{N}} [ {w}_{N}^{kl} ]}_{k , l = 0}^{N - 1}$$

having the primitive N^{th} roots of unity

$${w}_{N} = {e}^{- \frac{2 π j}{N}}$$

as the nodes of the DFT matrix. The scaled DFT matrix is denoted by \tilde{F}_{N}=\sqrt{N}F_{N}.

It is important to highlight that the O(N log N) DVM algorithm in Perera et al., 2022 (supra.) executes recursively utilizing the well-known FFTs in Cooley and Tukey (supra.) and Yavne (supra.).

Following the implementing the DVM algorithm 16-point DVM followed by multiplierless approximate 16-point and 32-point DFT matrices can be computed, having a product of highly sparse matrices (see also; Coelho et al., Multibeam digital array receiver using a 16-point multiplierless DFT approximation, IEEE Transactions on Antennas and Propagation, vol. 67, no. 2, pp. 925-933, 2019; and Mandal et al., Towards a low-swap 1024-beam digital array: A 32-beam subsystem at 5.8 GHZ, IEEE Transactions on Antennas and Propagation, vol. 68, pp. 900-912, 2020, api.semanticscholar.org/CorpusID:203035738; both of which are hereby incorporated herein by reference in their entireties). The ADFT factorization can then be embedded into the DVM algorithm in Perera et al., 2022 (supra.) to reduce the complexity of computing the DVM-vector product, reducing it from O(N²) to O(N).

Building on the DVM factorization and multiplierless ADFT factorization, a factorization can be stated to ADVM (see also, Perera et al., Linear order approximate-DVM algorithm for true time-delay multibeam beamforming, IEEE Transactions on Signal Processing, 2024; which is hereby incorporated by reference herein in its entirety).

Proposition 2.1: Let the scaled DVM

$${\tilde{A}}_{N} = {[ {α}^{kl} ]}_{k , l = 0}^{N - 1}$$

be defined by nodes {1, α, α², . . . α^{N-1}}∈ [symbol] , N=2^{r} (r≥3), and M=2N. Then, an approximation for the scaled DVM denoted as Â_{N} by vector x∈ [symbol] ^{×} or [symbol] ⁿ, i.e., y=Â_{N}x can be computed through the following:

$$y = {\hat{A}}_{N} x = {{\hat{D}}_{N} [ {J}_{M \times N} ]}^{T} {\hat{F}}_{M}^{*} {{D}^{⌣}}_{M} {\hat{F}}_{M} {J}_{M \times N} {\hat{D}}_{N} x ,$$

where \hat{F}_{N} is the ADFT matrix (see also Perera et al., 2024, supra.).

If it is assumed that multiplierless ADFT matrices were utilized in computing the scaled ADVM-vector product in Proposition 2.1, then the explicit delay complexity in computing the scaled DVM-vector product is 4N−2, which in turn has O(N) complexity.

Further, by following the multiplierless 16-point and 32-point DFT algorithms, compute the scaled ADVM-vector product can be explicitly computed with 6N-6, 8N-14, and 10N-30 when N=32, 64,128 (see also Coelho et al., supra., and Mandal et al., supra.). Thus, by following a series of complexity counts, it can be stated that the scaled ADVM-vector product has the linear order (i.e., multiplication complexity of O(N)) as opposed to the FFT-like O(N log N) complexity algorithms, for N=16 to 1024. On the other hand, the DVM-vector product calculates an ADVM algorithm as opposed to the exact DVM algorithms, but with O(N) complexity.

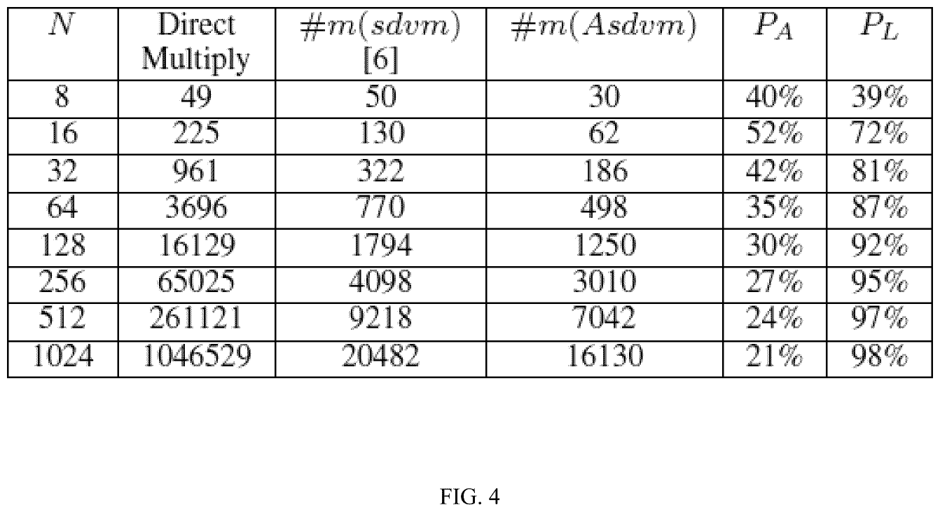

Wideband low-noise amplifiers (LNAs) and Vivaldi antennas must cover the frequency span of up to 32 GHz as this is a direct-digital architecture. Design of such components can be difficult and very expensive to procure. For example, the LNA ZVA-0.5W303GX+ from MiniCircuits covers up to 30 GHz, with gain of and noise figure 4.2 dB, and can be used as a transmit device. Similarly, MiniCircuits LVA-273PN-DG+ has frequency response up to 26.5 GHz, noise figure of about 10 dB, and gain of around 18 dB. The design of the front-end with up to eight such amplifiers can be difficult as these amplifiers cost several thousand dollars per unit and therefore careful optimized and cost-minimum design is a crucial requirement.

The signals of interest can be assumed to be of immense bandwidth, typically on the order of Fₛ/2=B=32 GHz per channel. Sampling such wideband signals requires special circuitry as a single analog-to-digital converter (ADC) typically would not be able to sample, hold, and quantize such bandwidth at reasonable levels of precision and power consumption. A time-interleave ADC with P parallel time-interleaved ADC sub-circuits can be assumed. Each of these P sub-ADCs can be further assumed to undergo temporal decimation by factor L such that the total number of parallel digital channels on the DSP would be PL and the digital clock period would be

$${F}_{Clk} = \frac{{F}_{s}}{PL} .$$

For example, assuming a channel bandwidth of 32 GHz and a Nyquist rate of Fₛ=64 GS/s, and a P=16 phase time-interleaved ADC, each sub-ADC will be sampling at 4 GS/s, with the DSP operating at F_{Clk}=256 MHz for a temporal decimation factor of L=16.

The digital delays operate within the field programmable gate array (FPGA) or application specific integrated circuit (ASIC) fabric at a sample rate of F_{Clk} megahertz (MHz), over PL parallel channels that make up the multirate DSP core that must finally realize any fractional delays or dot-products that are needed for the realization of the matrix analysis required in DVM wideband beamforming in real-time. The basic principle is as follows: let τᵤ be a fractional delay filter, which implies 0<τᵤ<1 with reference to the full-scale clock Fₛ GHz. A delay τᵤ causes a phase rotation in the frequency domain exp (−jωτᵤ), where ω is the normalized frequency variable with reference to the master sample rate Fₛ GHz.

An M-th order finite impulse response (FIR) can be designed and realized as a multirate filter to achieve the necessary fractional time sample delays. Typically, multiplications are directly correlated to filter order M that is required for the FIR filter for high bandwidth and precise operation, thereby causing FIR delays to be a major factor for complexity in multibeam systems. In the design, with PL=256, it can be assumed that M=16 for a reasonable reference design. The block-wise computation of the order-M FIR fractional delay filter (an interpolation operation between integer multiples of the clock at frequency Fₛ) can be realized as a matrix-vector product of the form y=Tx where Tis a banded Toeplitz matrix.

The structure of the banded Toeplitz matrix lends itself well for FFT-based computation and can be realized using the maximally-decimated uniform-DFT polyphase filterbank approach to efficient FIR filter realization. Here, the number of phases is PL=256, thus leading to a massively parallel digital architecture.

In the past, fully digital realizations of wideband beam-forming networks that operate over multi-GHz bandwidths have been only a dream due to the lack of ADC/digital-to-analog converter (DAC) and fast DSP technologies. However, recent innovations including the Series 9 Direct-RF Agilex (or Stratix) system on chip (SoC) using multi-chiplets packaged together, offer exciting possibilities for multibeam wideband DVM beamformers that span the legacy bands up to 7 GHZ (FR1), and upper mid-band (7 GHz-24 GHZ) and frequency range two (24 GHz-32 GHz) in a single antenna system and DSP platform. The fast O(N) linear delay-complexity digital DVM algorithm of embodiments of the subject invention is a key enabler that, when coupled with the latest direct-RF chiplets, leads to a new realm of possibilities for fully digital broadband antenna aperture arrays. The Series 9 Agilex Direct-RF chiplets offer 8 ADCs, 8 DACs, and an FPGA device on the same package, where each DAC/DAC can operate up to 64 GS/s (bandwidth of 32 GHZ) (see also FIG. 2).

Embodiments of the subject invention can utilize ADFT matrices (see also, Coelho et al., supra., Cintra et al., supra., and Mandal et al., supra.), which allows for the embedding of highly sparse and multiplierless ADFT into the O(N log N) complexity exact DVM algorithm from Perera et al., 2022 (supra.). This can result in the development of linear order ADVM algorithms ranging from 8-point to 1024-point. Additionally, an ADVM can be obtained that requires minimal multiplication (or analog delay) operations (see also; Silva et al., Inductorless analog time-delays for nonlinear RF signal processing circuits in 180 nm CMOS, in 2023 IEEE Microwaves, Antennas, and Propagation Conference (MAPCON), 2023, pp. 1-5; which is hereby incorporated by reference herein in its entirety). A main reason for proposing a linear order DVM algorithm is to reduce the chip area and power consumption in IC design; specifically in the context of wideband multibeam beamforming, the number of delays must be minimized. To pave the way for that, the signal flow graph (SFG) can be demonstrated for the approximate 16-point DVM algorithm (16-point ADVM). Although multiple different DVM algorithms exist, the DVM factorization presented in Perera et al., 2022 (supra.) can be used because it is the exact radix-2 DVM algorithm that executes recursively with the DFT to realize wideband multibeam beamformers.

The DVM can be explicitly defined by

$${A}_{N} := {[ {A}_{kl} ]}_{N} = {[ {α}^{kl} ]}_{k = 1 , l = 0}^{N , N - 1} ,$$

where N=2^{r} (r≥1), {α, α², . . . , α^{N}} are distinct complex nodes s.t. α=e^{-jωτ}, j²=−1, ω is the temporal frequency, and τ is the delay (see also; Perera et al., Wideband n-beam arrays with low-complexity algorithms and mixed-signal integrated circuits, IEEE Journal of Selected Topics in Signal Processing, vol. 12, no. 2, pp. 368-382, 2018; Perera, Madanayake, and Cintra, Efficient and self-recursive delay Vandermonde algorithm for multibeam antenna arrays, IEEE Open Journal of Signal Processing, vol. 1, no. 1, pp. 64-76, 2020; and Perera, Madanayake, and Cintra, Radix-2 Self-recursive Algorithms for Vandermonde-type Matrices and True-time-delay Multibeam Antenna Arrays, IEEE Access, vol. 8, pp. 25498-25508, 2020; all three of which are hereby incorporated by reference herein in their entireties). The scaled DVM (i.e., scaling with respect to a diagonal matrix) is defined as

$${\tilde{A}}_{N} := {[ {\tilde{A}}_{kl} ]}_{N} = {[ {α}^{kl} ]}_{k , l = 0}^{N - 1} .$$

The coefficient α^{kl} is a temporal Fourier transform of a pure time-delay of duration τ. The signal x(t) with Fourier transform X(ω) is related to the delayed version of the signal x(t−pτ) via the relationship X(ω)e^{-jpωτ}. Thus, the corresponding phase rotation of X(ω) is simply α^{p}=e^{-jpωτ}. Crucially, the DVM contains closed-form complex functions of ω given as complex phase rotations in integer powers p of α. That is, α^{p} are not numerical values; they are complex functions of frequency ω raised to power p. Hence, an N×N DVM containing powers of α looks like a matrix-vector product, but this is in the temporal Fourier domain, so this is defined O(N²) number of delay-and-sum dot product, not the usual O(N²) number of multiply-and-sum dot product.

The DFT matrix can be defined as

$${F}_{N} = {\frac{1}{\sqrt{N}} [ {w}_{N}^{kl} ]}_{k , l = 0}^{N - 1} .$$

A scaled DFT matrix can be defined as \tilde{F}_{N}=\sqrt{N}F_{N}, and the DFT factorization can be given

$${\tilde{F}}_{N} = {P}_{N}^{T} [ \begin{matrix}{F}_{\frac{N}{2}} & {0}_{\frac{N}{2}} \\ {0}_{\frac{N}{2}} & {F}_{\frac{N}{2}}\end{matrix} ] {H}_{N} ,$$

where for a given vector x=[x₀, x₁, . . . , x_{N-1}]^{T}∈R^{N}, an even-odd permutation matrix P_{N}(N≥3) is given via

$${P}_{N} x = \{ \begin{matrix}{[ {x}_{0} , {x}_{2} , ⋯ , {x}_{N - 2} , {x}_{1} , {x}_{3} , ⋯ , {x}_{N - 1} ]}^{T} & even N \\ {[ {x}_{0} , {x}_{2} , ⋯ , {x}_{N - 1} , {x}_{1} , {x}_{3} , ⋯ , {x}_{N - 2} ]}^{T} & odd N\end{matrix} ,$$

the scaled orthogonal matrix is given by

$${H}_{N} = [ \begin{matrix}{I}_{\frac{N}{2}} & {I}_{\frac{N}{2}} \\ {{D}^{`}}_{\frac{N}{2}} & - {{D}^{`}}_{\frac{N}{2}}\end{matrix} ] .$$

the diagonal matrix is given by

$${{D}^{`}}_{\frac{N}{2}} = {diag [ {w}_{N}^{l} ]}_{l = 0}^{\frac{N}{2} - 1} ,$$

the identity matrix is given by I_{N}, and the zero matrix is via 0_{N}.

The scaled DVM factorization in Perera et al., 2022 (supra.) can be defined as

$${{\tilde{A}}_{N} = {\hat{D}}_{N} ⌈ {J}_{M \times N} ]}^{T} {F}_{M}^{*} {{D}^{⌣}}_{M} {F}_{M} {J}_{M \times N} {\hat{D}}_{N} , where M = 2 N , {J}_{M \times N} = [ \frac{{I}_{N}}{{0}_{N}} ]$$

is a highly sparse matrix, diagonal matrices by

$${D}_{N} = {diag [ {α}^{k} ]}_{k = 0}^{N - 1} , {\hat{D}}_{N} = {diag [ {α}^{\frac{{k}^{2}}{2}} ]}^{N - 1} ,$$

and [symbol] _{M}=diag [\tilde{F}_{M}C], a circulant matrix C_{M} defined by the first column

$$c s . t . c = {[ 1 , {α}^{- \frac{1}{2}} , … , {α}^{- \frac{{( N - 1 )}^{2}}{2}} , 1 , {α}^{- \frac{{( N - 1 )}^{2}}{2}} , {α}^{- \frac{{( N - 2 )}^{2}}{2}} , … , {α}^{- \frac{1}{2}} ]}^{T} .$$

Let N-point ADFT be defined as \hat{F}_{N}. Coelho et al. (supra.) presents an approximation of the 16-point DFT s.t. \hat{F}₁₆ is expressed as a product of highly sparse matrices factors and is given via \hat{F}₁₆=P₂·B₅·P₁·D·B₄·B₃·B₂·B₁. Also, Mandal et al. (supra.) provides an approximation of the 32-point DFT, s.t., \hat{F}₃₂=W₈·W₇·W₆·W₅·W₄·W₃·W₂·W₁.

Proposition 2.2: The 32-point ADFT factorization can be given via

$${{F}^{⌢}}_{32} = {S}_{4} \cdot {S}_{3} \cdot {S}_{2} \cdot {S}_{1} \cdot {S}_{0} , \qquad ( 1 )$$

where S₀=W₁, S₁=W₃·W₂, S₂=W₅·W₄, S₃=W₇·W₆, and S₄=W₈ (see also Mandal et al., supra.).

Proof. This is trivial by the matrix multiplication while setting S₁=W₃·W₂, S₂=W₅·W₄, and S₃=W₇·W₆ in Mandal et al. (supra.). These Si matrices for i=0, 1, . . . , 4, are explicitly given as follows.

The explicit factorization for \hat{F}₃₂, where \hat{F}₃₂=S₄·S₃·S₂·S₁·S₀, will now be presented. Let the matrices in the factorization of \hat{F}₃₂ be defined as

$${S}_{0} = [ \begin{matrix}{S}_{0 , 11} & {0}_{17} \\ {0}_{15} & {S}_{0 , 22}\end{matrix} ] ,$$

where the block submatrices S_{0,11} and S_{0,22} are derived as

$${S}_{0 , 11} = [ \begin{matrix}1 & & & & & & & & & & & & & & & & 1 \\ & 1 & & & & & & & & & & & & & & 1 & \\ & & 1 & & & & & & & & & & & & 1 & & \\ & & & 1 & & & & & & & & & & 1 & & & \\ & & & & 1 & & & & & & & & 1 & & & & \\ & & & & & 1 & & & & & & 1 & & & & & \\ & & & & & & 1 & & & & 1 & & & & & & \\ & & & & & & & 1 & & 1 & & & & & & & \\ & & & & & & & & 1 & & & & & & & & \\ & & & & & & & 1 & & - 1 & & & & & & & \\ & & & & & & 1 & & & & - 1 & & & & & & \\ & & & & & 1 & & & & & & - 1 & & & & & \\ & & & & 1 & & & & & & & & - 1 & & & & \\ & & & 1 & & & & & & & & & & - 1 & & & \\ & & 1 & & & & & & & & & & & & - 1 & & \\ & 1 & & & & & & & & & & & & & & - 1 & \\ 1 & & & & & & & & & & & & & & & & - 1\end{matrix} ]$$

$$and$$

$${S}_{0 , 22} = [ \begin{matrix}1 & & & & & & & & & & & & & & 1 \\ & 1 & & & & & & & & & & & & 1 & \\ & & 1 & & & & & & & & & & 1 & & \\ & & & 1 & & & & & & & & 1 & & & \\ & & & & 1 & & & & & & 1 & & & & \\ & & & & & 1 & & & & 1 & & & & & \\ & & & & & & 1 & & 1 & & & & & & \\ & & & & & & & 1 & & & & & & & \\ & & & & & & 1 & & - 1 & & & & & & \\ & & & & & 1 & & & & - 1 & & & & & \\ & & & & 1 & & & & & & - 1 & & & & \\ & & & 1 & & & & & & & & - 1 & & & \\ & & 1 & & & & & & & & & & - 1 & & \\ & 1 & & & & & & & & & & & & - 1 & \\ 1 & & & & & & & & & & & & & & - 1\end{matrix} ] .$$

The S₁ matrix is defined as

$${S}_{1} = [ \begin{matrix}{S}_{1 , 11} & {S}_{1 , 12} \\ {S}_{1 , 21} & {S}_{1 , 22}\end{matrix} ] ,$$

where the block submatrices S_{1,11}, S_{1,12}, S_{1,21}, and S_{1,22} are given via

$${S}_{1 , 11} = [ \begin{matrix}1 & & & & & & & & 1 & & & & & & & \\ & 1 & & & & & & 1 & & & & & & & & \\ & & 1 & & & & 1 & & & & & & & & & \\ & & & 1 & & 1 & & & & & & & & & & \\ & & & & 1 & & & & & & & & & & & \\ & & & 1 & & - 1 & & & & & & & & & & \\ & & 1 & & & & - 1 & & & & & & & & & \\ & 1 & & & & & & - 1 & & & & & & & & \\ 1 & & & & & & & & - 1 & & & & & & & \\ & & & & & & & & & 1 & & & & & & 1 \\ & & & & & & & & & & 1 & & & & 1 & \\ & & & & & & & & & & & 1 & & 1 & & \\ & & & & & & & & & & & & 1 & & & \\ & & & & & & & & & & & 1 & & - 1 & & \\ & & & & & & & & & & 1 & & & & - 1 & \\ & & & & & & & & & 1 & & & & & & - 1\end{matrix} ] ,$$

$${S}_{1 , 12} = [ \begin{matrix}1 & & & & & & & 1 & & & & & & & \\ & 1 & & & & & 1 & & & & & & & & \\ & & 1 & & & 1 & & & & & & & & & \\ & & & 1 & 1 & & & & & & & & & & \\ & & 1 & & - 1 & & & & & & & & & & \\ & 1 & & & & - 1 & & & & & & & & & \\ 1 & & & & & & - 1 & & & & & & & & \\ & & & & & & & - 1 & & & & & & & \\ & & & & & & & & 1 & & & & & & 1 \\ & & & & & & & & & 1 & & & & 1 & \\ & & & & & & & & & & 1 & & 1 & & \\ & & & & & & & & & & & 1 & & & \\ & & & & & & & & & & 1 & & - 1 & & \\ & & & & & & & & & 1 & & & & - 1 & \\ & & & & & & & & 1 & & & & & & - 1\end{matrix} ]$$

$${S}_{1 , 21} = [ {}_{}^{0} {I}_{15}^{} ] , and$$

$${S}_{1 , 22} = [ \begin{matrix}1 & & & & & & & & & & & & & & & \\ & - 1 & & & & & & & & & & & & & & \\ & & - 1 & & & & & & & & & & & & & \\ & & & - 1 & & & & & & & & & & & & \\ & & & & - 1 & & & & & & & & & & & \\ & & & & & - 1 & & & & & & & & & & \\ & & & & & & - 1 & & & & & & & & & \\ & & & & & & & - 1 & & & & & & & & \\ & & & & & & & & - 1 & & & & & & & \\ & & & & & & & & & - 1 & & & & & & \\ & & & & & & & & & & - 1 & & & & & \\ & & & & & & & & & & & - 1 & & & & \\ & & & & & & & & & & & & - 1 & & & \\ & & & & & & & & & & & & & - 1 & & \\ & & & & & & & & & & & & & & - 1 & \\ & & & & & & & & & & & & & & & - 1\end{matrix} ]$$

The S₂ is defined as

$${S}_{2} = [ \begin{matrix}{S}_{2 , 11} & {0}_{16} \\ {0}_{16} & {S}_{2 , 22}\end{matrix} ] ,$$

where the block submatrices S_{2,11} and S_{2,22} are given via

$${S}_{2 , 11} = [ \begin{matrix}1 & & 1 & & 1 & & & & & & & & & & & \\ & 1 & & 1 & & & & & & & & & & & & \\ 1 & & - 1 & & 1 & & & & & & & & & & & \\ 1 & 1 & & - 1 & - 1 & & & & & & & & & & & \\ - 1 & 1 & & - 1 & 1 & & & & & & & & & & & \\ & & & & & 1 & 1 & & - 1 & & & & & & & \\ & & & & & & 1 & 1 & 1 & & & & & & & \\ & & & & & & 1 & - 1 & 1 & & & & & & & \\ & & & & & 1 & - 1 & & 1 & & & & & & & \\ & & & & & & & & & 1 & 1 & & - 1 & & & \\ & & & & & & & & & & 1 & 1 & 1 & & & \\ & & & & & & & & & & 1 & - 1 & 1 & & & \\ & & & & & & & & & 1 & - 1 & & 1 & & & \\ & & & & & & & & & & & & & 1 & 1 & 1 \\ & & & & & & & & & & & & & 1 & - 1 & 1 \\ & & & & & & & & & & & & & 1 & & - 1\end{matrix} ]$$

$$and$$

$${S}_{2 , 22} = [ \begin{matrix}- 1 & & & & & & & & & & & & - 1 & & 1 & \\ & 1 & & & & & & & & & & & & & & \\ & & 1 & & 1 & & & & - 1 & & & & & & & \\ & & & 1 & & 1 & & 1 & & & & & & & & \\ & & & & 1 & & 1 & & 1 & & & & & & & \\ & & & 1 & & - 1 & & & & & & & & & & \\ & & & & 1 & & - 1 & & 1 & & & & & & & \\ & & & 1 & & & & - 1 & & & & & & & & \\ & & 1 & & - 1 & & & 1 & & & & & & & & \\ & & & & & & & & & 1 & & & & & & \\ 1 & & & & & & & & & & 1 & & - 1 & & & \\ & & & & & & & & & & & 1 & & 1 & & 1 \\ - 1 & & & & & & & & & & 1 & & 1 & & & \\ & & & & & & & & & & & 1 & & - 1 & & \\ 1 & & & & & & & & & & & & 1 & & 1 & \\ & & & & & & & & & & & 1 & & & & - 1\end{matrix} ]$$

The S₃ is defined as

$${S}_{3} = [ \begin{matrix}{S}_{3 , 11} & {0}_{16} \\ {0}_{16} & {S}_{3 , 22}\end{matrix} ] ,$$

where the block submatrices S_{3,11} and S_{3,22} are given via

$${S}_{3 , 11} = [ \begin{matrix}1 & 1 & \\ 1 & - 1 & \\ & & {I}_{14}\end{matrix} ] and$$

$${S}_{3 , 22} = [ \begin{matrix}1 & & & & & & & & & 1 & & & - 1 & & & \\ & 1 & & & & 1 & & - 1 & 1 & & & & & & & \\ & 1 & - 1 & & & & & 1 & & & & & & & & \\ & & & 1 & 1 & & & & & & & & & & & \\ & & & 1 & - 1 & & & & & & & & & & & \\ & 1 & & & & - 1 & 1 & & & & & & & & & \\ & 1 & & & & - 1 & - 1 & & & & & & & & & \\ & 1 & 1 & & & & & 1 & & & & & & & & \\ & 1 & & & & 1 & & - 1 & - 1 & & & & & & & \\ & & & & & & & & & 1 & 1 & & 1 & & & - 1 \\ & & & & & & & & & 1 & - 1 & & 1 & & & - 1 \\ & & & & & & & & & & & 1 & & & 1 & \\ & & & & & & & & & 1 & & & 1 & & & 1 \\ 1 & & & & & & & & & - 1 & & & & 1 & & \\ & & & & & & & & & & & 1 & & & - 1 & \\ & & & & & & & & & - 1 & & & 1 & & & - 1\end{matrix} ]$$

The S₄ matrix is defined as

$${S}_{4} = [ \begin{matrix}1 & & & & & & & & & & & - j & & & & & 1 & & & \\ & & & 1 & & - j & & & & & & & & & & & & & & \\ & 1 & & & & & & j & & & & & & - j & & & & - 1 & & \\ & & & & & & & & & - j & & & & & & 1 & & & & \\ & & - 1 & & - j & & & & & & & & & & & & & & & \\ & & & & & & & & - 1 & & & & - j & & & & & & & \\ 1 & & & & & & & - j & & & & & & & & & & & & \\ & & & & & & & & & & & - j & & & & & & & - 1 & \\ & & & 1 & & - j & & & & & & & & & & & & & & \\ & & & & & & & & & & & & & - j & - 1 & & & & & \\ & - 1 & & & & & j & & & & & & & & & & & & & \\ & & & & & & & & & - j & & & & & & & & & & - 1 \\ & & 1 & & j & & & & & & & & & & & & & & & \\ 1 & & & & & & & & & & - j & & & & & & & & - 1 & \\ & & & & & & & & & & j & & & & & & & & - 1 & \\ & & & & & & & & & & & & & & & & & & & \\ & & 1 & & - j & & & & & j & & & & & & & & & & \\ & - 1 & & & & & & & & & & & & j & - 1 & & & & & - 1 \\ & & 1 & & & j & & & & & & j & & & & & & - 1 & & \\ & & & & & & & & & & & & & & & & & & & \\ 1 & & & & & & j & & & & & & & & & & - 1 & & & \\ & & & & & & & - 1 & & & & & j & & & & & & & \\ & & - 1 & & j & & & & & & & & & & & & & & & \\ & & & & & & & & j & & & & & & 1 & & & & & \\ & 1 & & & & & & & & & & & j & & & & - 1 & & & \\ & & & & & & & & & & & & & & & & & & & \\ & & & & & & & & & & & & & & & & & & & \\ & & 1 & & j & & & & & & & & & & & & & & & \\ & & & & & & & & & j & & & & & & 1 & & & & \end{matrix} ]$$

The explicit 32-point ADFT matrix can be denoted as follows

$${{F}^{⌢}}_{32} = [ \begin{matrix}{F}_{32 , 11} & {F}_{32 , 12} \\ {F}_{32 , 21} & {F}_{32 , 22}\end{matrix} ] , where$$

$${F}_{32 , 11} = [ \begin{matrix}1 & 1 & 1 & 1 & 1 & 1 & 1 & 1 & 1 & 1 & 1 & 1 & 1 & 1 & 1 & 1 \\ 1 & 1 & 1 & 1 - j & 1 - j & 1 - j & - j & - j & - j & - j & - j & - 1 - j & - 1 - j & - 1 - j & - 1 & - 1 \\ 1 & 1 & 1 - j & - j & - j & - j & - 1 - j & - 1 & - 1 & - 1 & - 1 + j & j & j & j & 1 + j & 1 \\ 1 & 1 - j & - j & - j & - 1 - j & - 1 & - 1 & - 1 + j & j & 1 + j & 1 & 1 & 1 - j & - j & - j & - 1 - j \\ 1 & 1 - j & - j & - 1 - j & - 1 & - 1 + j & j & 1 + j & 1 & 1 - j & - j & - 1 - j & - 1 & - 1 + j & j & 1 + j \\ 1 & 1 - j & - j & - 1 & - 1 + j & j & 1 & 1 - j & - j & - 1 - j & - 1 & j & 1 + j & 1 & - j & - 1 - j \\ 1 & - j & - 1 - j & - 1 & j & 1 & 1 - j & - j & - 1 & j & 1 + j & 1 & - j & - 1 & - 1 + j & j \\ 1 & - j & - 1 & - 1 + j & 1 + j & 1 - j & - j & - 1 & j & 1 & - j & - 1 - j & - 1 + j & 1 + j & 1 & - j \\ 1 & - j & - 1 & j & 1 & - j & - 1 & j & 1 & - j & - 1 & j & 1 & - j & - 1 & j \\ 1 & - j & - 1 & 1 + j & 1 - j & - 1 - j & j & 1 & - j & - 1 & j & 1 - j & - 1 - j & - 1 + j & 1 & - j \\ 1 & - j & - 1 + j & 1 & - j & - 1 & 1 + j & - j & - 1 & j & 1 - j & - 1 & j & 1 & - 1 - j & j \\ 1 & - 1 - j & j & 1 & - 1 - j & j & 1 & - 1 - j & j & 1 - j & - 1 & j & 1 - j & - 1 & j & 1 - j \\ 1 & - 1 - j & j & 1 - j & - 1 & 1 + j & - j & - 1 + j & 1 & - 1 - j & j & 1 - j & - 1 & 1 + j & - j & - 1 + j \\ 1 & - 1 - j & j & - j & - 1 + j & 1 & - 1 & 1 + j & - j & - 1 + j & 1 & - 1 & 1 + j & - j & j & 1 - j \\ 1 & - 1 & 1 + j & - j & j & - j & - 1 + j & 1 & - 1 & 1 & - 1 - j & j & - j & j & 1 - j & - 1 \\ 1 & - 1 & 1 & - 1 - j & 1 + j & - 1 - j & j & - j & j & - j & j & 1 - j & - 1 + j & 1 - j & - 1 & 1\end{matrix} ]$$

$${F}_{32 , 12} = [ \begin{matrix}1 & 1 & 1 & 1 & 1 & 1 & 1 & 1 & 1 & 1 & 1 & 1 & 1 & 1 & 1 & 1 \\ - 1 & - 1 & - 1 & - 1 + j & - 1 + j & - 1 + j & j & j & j & j & j & 1 + j & 1 + j & 1 + j & 1 & 1 \\ 1 & 1 & 1 - j & - j & - j & - j & - 1 - j & - 1 & - 1 & - 1 & - 1 + j & j & j & j & 1 + j & 1 \\ - 1 & - 1 + j & j & j & 1 + j & 1 & 1 & 1 - j & - j & - 1 - j & - 1 & - 1 & - 1 + j & j & j & 1 + j \\ 1 & 1 - j & - j & - 1 - j & - 1 & - 1 + j & j & 1 + j & 1 & 1 - j & - j & - 1 - j & - 1 & - 1 + j & j & 1 + j \\ - 1 & - 1 + j & j & 1 & 1 - j & - j & - 1 & - 1 + j & j & 1 + j & 1 & - j & - 1 - j & - 1 & j & 1 + j \\ 1 & - j & - 1 - j & - 1 & j & 1 & 1 - j & - j & - 1 & j & 1 + j & 1 & - j & - 1 & - 1 + j & j \\ - 1 & j & 1 & 1 - j & - 1 - j & - 1 + j & j & 1 & - j & - 1 & j & 1 + j & 1 - j & - 1 - j & - 1 & j \\ 1 & - j & - 1 & j & 1 & - j & - 1 & j & 1 & - j & - 1 & j & 1 & - j & - 1 & j \\ - 1 & j & 1 & - 1 - j & - 1 + j & 1 + j & - j & - 1 & j & 1 & - j & - 1 + j & 1 + j & 1 - j & - 1 & j \\ 1 & - j & - 1 + j & 1 & - j & - 1 & 1 + j & - j & - 1 & j & 1 - j & - 1 & j & 1 & - 1 - j & j \\ - 1 & 1 + j & - j & - 1 & 1 + j & - j & - 1 & 1 + j & - j & - 1 + j & 1 & - j & - 1 + j & 1 & - j & - 1 + j \\ 1 & - 1 - j & j & 1 - j & - 1 & 1 + j & - j & - 1 + j & 1 & - 1 - j & j & 1 - j & - 1 & 1 + j & - j & - 1 + j \\ - 1 & 1 + j & - j & j & 1 - j & - 1 & 1 & - 1 - j & j & 1 - j & - 1 & 1 & - 1 - j & j & - j & - 1 + j \\ 1 & - 1 & 1 + j & - j & j & - j & - 1 + j & 1 & - 1 & 1 & - 1 - j & j & - j & j & 1 - j & - 1 \\ - 1 & 1 & - 1 & 1 + j & - 1 - j & 1 + j & - j & j & - j & j & - j & - 1 + j & 1 - j & - 1 + j & 1 & - 1\end{matrix} ]$$

$${F}_{32 , 21} = [ \begin{matrix}1 & - 1 & 1 & - 1 & 1 & - 1 & 1 & - 1 & 1 & - 1 & 1 & - 1 & 1 & - 1 & 1 & - 1 \\ 1 & - 1 & 1 & - 1 + j & 1 - j & - 1 + j & - j & j & - j & - 1 - j & - j & 1 + j & - 1 - j & 1 + j & - 1 & 1 \\ 1 & - 1 & 1 - j & j & - j & j & - 1 - j & 1 & - 1 & 1 & - 1 + j & - j & j & - j & 1 + j & - 1 \\ 1 & - 1 + j & - j & j & - 1 - j & 1 & - 1 & 1 - j & j & - 1 - j & 1 & - 1 & 1 - j & j & - j & 1 + j \\ 1 & - 1 + j & - j & 1 + j & - 1 & 1 - j & j & - 1 - j & 1 & - 1 + j & - j & 1 + j & - 1 & 1 - j & j & - 1 - j \\ 1 & - 1 + j & - j & 1 & - 1 + j & - j & 1 & - 1 + j & - j & 1 + j & - 1 & - j & 1 + j & - 1 & - j & 1 + j \\ 1 & j & - 1 - j & 1 & j & - 1 & 1 - j & j & - 1 & - j & 1 + j & - 1 + j & - j & 1 & - 1 + j & - j \\ 1 & j & - 1 & 1 - j & 1 + j & - 1 + j & - j & 1 & j & - 1 & - j & 1 & - 1 + j & - 1 - j & 1 & j \\ 1 & j & - 1 & - j & 1 & j & - 1 & - j & 1 & j & - 1 & - j & 1 & j & - 1 & - j \\ 1 & j & - 1 & - 1 - j & 1 - j & 1 + j & j & - 1 & - j & 1 & j & - 1 + j & - 1 - j & 1 - j & 1 & j \\ 1 & j & - 1 + j & - 1 & - j & 1 & 1 + j & j & - 1 & - j & 1 - j & 1 & j & - 1 & - 1 - j & - j \\ 1 & 1 + j & j & - 1 & - 1 - j & - j & 1 & 1 + j & - j & - 1 + j & - 1 & - j & 1 - j & 1 & j & - 1 + j \\ 1 & 1 + j & j & - 1 + j & - 1 & - 1 - j & - j & 1 - j & 1 & 1 + j & j & - 1 + j & - 1 & - 1 - j & - j & 1 - j \\ 1 & 1 + j & j & j & - 1 + j & - 1 & - 1 & - 1 - j & - j & 1 - j & 1 & 1 & 1 + j & j & j & - 1 + j \\ 1 & 1 & 1 + j & j & j & j & - 1 + j & - 1 & - 1 & - 1 & - 1 - j & - j & - j & - j & 1 - j & 1 \\ 1 & 1 & 1 & 1 + j & 1 + j & 1 + j & j & j & j & j & j & - 1 + j & - 1 + j & - 1 + j & - 1 & - 1\end{matrix} ]$$

$${F}_{32 , 22} = [ \begin{matrix}1 & - 1 & 1 & - 1 & 1 & - 1 & 1 & - 1 & 1 & - 1 & 1 & - 1 & 1 & - 1 & 1 & - 1 \\ - 1 & 1 & - 1 & 1 - j & - 1 + j & 1 - j & j & - j & j & - j & j & - 1 - j & 1 + j & - 1 - j & 1 & - 1 \\ 1 & - 1 & 1 - j & j & - j & j & - 1 - j & 1 & - 1 & 1 & - 1 + j & - j & j & - j & 1 + j & - 1 \\ - 1 & 1 - j & j & - j & 1 + j & - 1 & 1 & - 1 + j & - j & 1 + j & - 1 & 1 & - 1 + j & - j & j & - 1 - j \\ 1 & - 1 + j & - j & 1 + j & - 1 & 1 - j & j & - 1 - j & 1 & - 1 + j & - j & 1 + j & - 1 & 1 - j & j & - 1 - j \\ - 1 & 1 - j & j & - 1 & 1 - j & j & - 1 & 1 - j & j & - 1 - j & 1 & j & - 1 - j & 1 & j & - 1 - j \\ 1 & j & - 1 - j & 1 & j & - 1 & 1 - j & j & - 1 & - j & 1 + j & - 1 & - j & 1 & - 1 + j & - j \\ - 1 & - j & 1 & - 1 + j & - 1 - j & 1 - j & j & - 1 & - j & 1 & j & - 1 - j & 1 - j & 1 + j & - 1 & - 1 \\ 1 & j & - 1 & - j & 1 & j & - 1 & - j & 1 & j & - 1 & - j & 1 & j & - 1 & - 1 \\ - 1 & - j & 1 & 1 + j & - 1 + j & - 1 - j & - j & 1 & j & - 1 & - j & 1 - j & 1 + j & - 1 + j & - 1 & - j \\ 1 & j & - 1 + j & - 1 & - j & 1 & 1 + j & j & - 1 & - j & 1 - j & 1 & j & - 1 & - 1 - j & - j \\ - 1 & - 1 - j & - j & 1 & 1 + j & j & - 1 & - 1 - j & - j & 1 - j & 1 & j & - 1 + j & - 1 & - j & 1 - j \\ 1 & 1 + j & j & - 1 + j & - 1 & - 1 - j & - j & 1 - j & 1 & 1 + j & j & - 1 + j & - 1 & - 1 - j & - j & 1 - j \\ - 1 & - 1 - j & - j & - j & 1 - j & 1 & 1 & 1 + j & j & - 1 + j & - 1 & - 1 & - 1 - j & - j & - j & 1 - j \\ 1 & 1 & 1 + j & j & j & j & - 1 + j & - 1 & - 1 & - 1 & - 1 - j & - j & - j & - j & 1 - j & 1 \\ - 1 & - 1 & - 1 & - 1 - j & - 1 - j & - 1 - j & - j & - j & - j & - j & - j & 1 - j & 1 - j & 1 - j & 1 & 1\end{matrix} ]$$

The conjugate transpose of the ADFT can be easily observed as

$${\hat{F}}_{32}^{*} = {S}_{0}^{T} \cdot {S}_{1}^{T} \cdot {S}_{2}^{T} \cdot {S}_{3}^{T} \cdot {S}_{4}^{*} .$$

Here, the symbol ^{T} represents the transpose operation applied to matrices. This insight can be utilized to embed it into the DVM factorization and derive an ADVM.

A factorization can be presented to obtain an approximation for the scaled DVM from 8-point to N-point while reducing the arithmetic complexity. The ADVM algorithm of embodiments of the subject invention has linear order multiplication complexity.

Proposition 2.3: Let the scaled DVM

$${\tilde{A}}_{N} = {[ {α}^{kl} ]}_{k , l = 0}^{N - 1}$$

defined by nodes {1, α, α2, . . . , α^{N-1}}∈ [symbol] , N=8 or 16, and M=2N (see also Perera et al., 2022, supra.). Then, an approximation for the scaled DVM, denoted as AN, can be obtained through the following:

$${{A}^{⌢}}_{N} = {{\hat{D}}_{N} [ {J}_{M \times N} ]}^{T} {{F}^{⌢}}_{M}^{+} {{D}^{⌣}}_{M} {{F}^{⌢}}_{M} {J}_{M \times N} {\hat{D}}_{N} . \qquad ( 2 )$$

Proof. This is trivial from the DVM factorization in Perera et al., 2022 (supra.) followed by Proposition III-B (see also Coelho et al., supra.).

When N=8 and 16, the ADFT factorization described in Coelho et al. (supra.) and Mandal et al. (supra.), respectively, can be used. Now, a factorization formula will be presented that can be used to ADVM from 32 points and beyond.

Corollary 2.4: Let the scaled DVM

$${\tilde{A}}_{N} = {[ {α}^{kl} ]}_{k , l = 0}^{N - 1}$$

be defined by nodes {1, α, α², . . . , α^{N-1}}∈ [symbol] , N=2^{r} (r≥5), and M=2N. Then, an approximation for the scaled DVM: Â_{N} can be obtained via the following:

$${\hat{A}}_{N} = {{\hat{D}}_{N} [ {J}_{M \times N} ]}^{T} {\hat{F}}_{M}^{*} {{D}^{⌣}}_{M} {\hat{F}}_{M} {J}_{M \times N} {\hat{D}}_{N} , \qquad ( 3 )$$

$$where {\hat{F}}_{M} = {P}_{M}^{T} [ \begin{matrix}{\hat{F}}_{N} & \\ & {\hat{F}}_{N}\end{matrix} ] {H}_{M} .$$

Proof. This follows immediately from the Proposition (II.3) and ADFT matrices by self-contained factors beyond 32-point.

Following the ADVM factorization discussed above, embodiments of the subject invention provide scaled ADVM algorithms that execute recursively with ADFT algorithms, initialized with the 16-point ADVM. To further reduce the multiplication counts in computing the matrix-vector product, the factor

$$\frac{1}{\sqrt{M}}$$

### in F_{M} and

$${F}_{M}^{*}$$

can be moved to the end of the computation, and hence y=MÂ_{N}Z can be computed. The ADVM algorithm has O(N) as opposed to O(N log N) complexity for N=8, 16, 32, 64, 128, 256, 512, 1024, 2048, 4096, 8192.

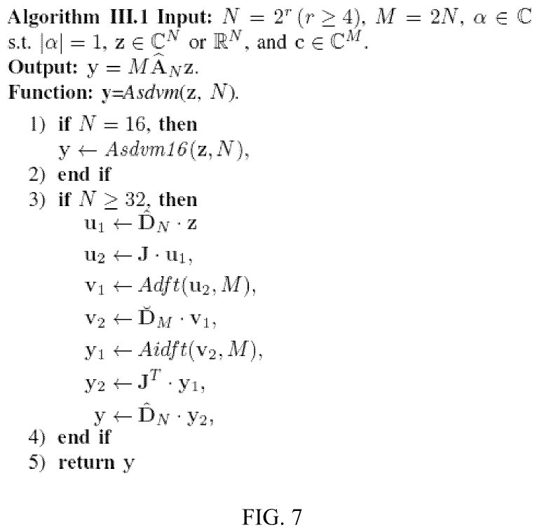

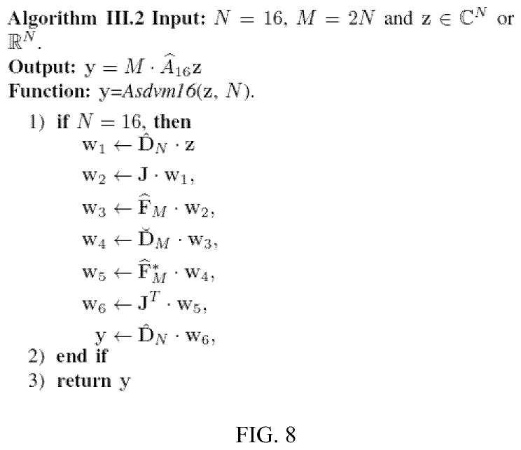

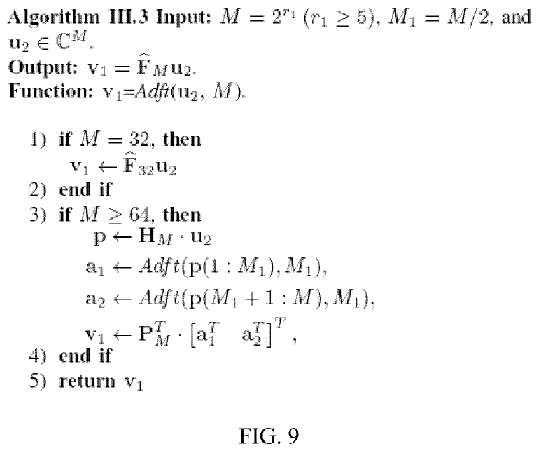

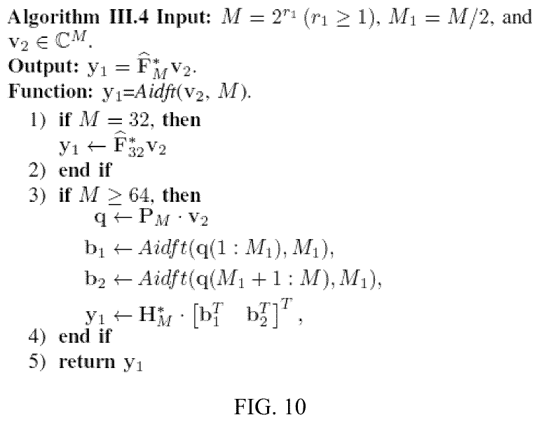

The factorization for the ADVM is self-explanatory for N=4, 8 and obtaining the approximate algorithm may not be necessary. FIG. 7 shows a scaled ADVM algorithm to compute the product of a scaled DVM by a vector (i.e., y=MÂ_{N}z for a given N, α, z∈ [symbol] ^{N} or [symbol] ^{N} and c∈ [symbol] ^{M}). The scaled ADVM algorithm in FIG. 7 (which can be referred to herein as “Asdvm”) can execute recursively initialized with the 16-point ADVM followed by the scaled approximate FFTs. The scaled approximate FFT and approximate inverse FFT algorithms (which can be referred to herein as “Adft” and “Aidft”, respectively) are shown in FIGS. 9 and 10, respectively. FIG. 8 shows the 16-point ADVM algorithm (which can be referred to herein as “Asdvm16”).

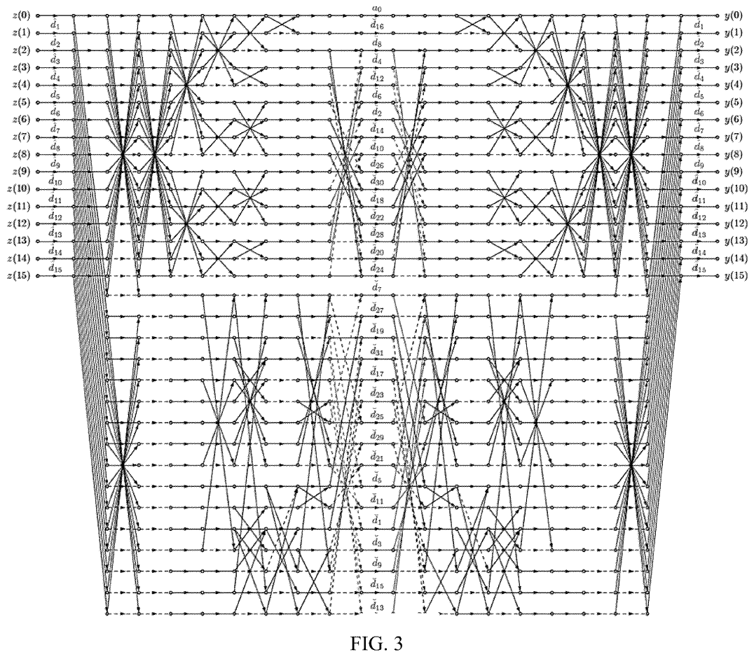

Based on the algorithms shown in FIGS. 7 and 8, building blocks can be shown in the signal flow graph drawn for the 16-point scaled ADVM algorithm and shown in FIG. 3. The Asdvm algorithm can be stated based on the sparse factorization in Proposition II.3, and hence the factorization for the scaled ADVM can be stated as follows.

$$32 {\hat{A}}_{16} = {\hat{D}}_{16} [ {I}_{16} \vert {0}_{16} ] {\hat{F}}_{32}^{*} {{D}^{⋁}}_{32} {\hat{F}}_{32} [ \frac{{I}_{16}}{{0}_{16}} ] {\hat{D}}_{16} ,$$

$${\hat{D}}_{16} = [ \begin{matrix}1 & & & \\ & {\hat{d}}_{1} & & \\ & & ⋱ & \\ & & & {\hat{d}}_{15}\end{matrix} ] , {{D}^{⋁}}_{32} +$$

where

$$[ \begin{matrix}{{d}^{⋁}}_{0} & & & \\ & {{d}_{1}}^{⌣} & & \\ & & ⋱ & \\ & & & {{d}^{⌣}}_{31}\end{matrix} ] ,$$

$${\hat{F}}_{32}^{*} := the conjugate transpose of the ADFT {\hat{F}}_{32} ,$$

and the sparse factorization for the \hat{F}₃₂ can be obtained from Proposition III-B (see also Coelho et al., supra.).

The number of multiplications (say #m) (i.e., gain-delay blocks; see also Perera et al., 2022, supra.) required to compute the algorithm shown in FIG. 7 can be obtained. Counts can be obtained to compute the scaled ADVM algorithm, which executes recursively with the scaled approximate FFTs (to reduce the multiplication counts). Thus, the number of multiplications required to compute y=\hat{F}_{N}Z can be taken, where z∈ [symbol] ^{N}, as 0 for N=32, when the multiplications by ±1 and ±j are not counted, and Adft and Aidft algorithms can be used to obtain counts to compute y=\hat{F}_{N}z for N>32.

Lemma 2.5: Let N=2^{r}, r≥4 be given. The scaled ADVM algorithm (i.e., Algorithm Asdvm) can recursively be computed using Asdvm16, Adft, and Aidft algorithms with the following gain-delay block counts:

$$\# m ( Asdvm , N ) = 4 N - 2 , for N = 16 \qquad ( 4 )$$

$$\# m ( Asdvm , N ) = 6 N - 6 , for N = 32$$

$$\# m ( Asdvm , N ) = 8 N - 14 , for N = 64$$

$$\# m ( Asdvm , N ) = 10 N - 30 , for N = 128$$

$$\# m ( Asdvm , N ) = 12 N - 62 , for N = 256$$

$$\# m ( Asdvm , N ) = 14 N - 126 , for N = 512$$

$$\# m ( Asdvm , N ) = 16 N - 254 , for N = 1024$$

$$\# m ( Asdvm , N ) = 2 Nr - \frac{17}{4} N + 2 , for N > 1024.$$

Proof. Referring to the scaled ADVM algorithm, the following is derived:

$$\# m ( Asdvm , N ) = 2 ( \# m ( {{F}^{⌢}}_{M} ) ) + 2 ( \# ( {\hat{D}}_{N} ) ) + 2 ( \# m ( J ) ) + \# m ( {{D}^{⋁}}_{M} ) . \qquad ( 5 )$$

Following the structures of \hat{D}_{N}, J, and [symbol] _{M} multiplierless the multiplication of each matrix by a complex input, the following is obtained:

$$\# m ( J ) = 0 , \# ( {\hat{D}}_{N} ) = N - 1 , \# m ( {{D}^{⋁}}_{M} ) = M .$$

Following the ADFT factorization for 32-point, and using that with the Adft, and Aidft algorithms, the following counts can be obtained to compute the ADFT by a vector (except multiplication by ±1 and ±j): #m (\hat{F}_{M})=0, N−2, 2N−6, . . . , 6N−126, respectively, for N=16, 32, 64, . . . , 1024. Thus, to compute the ADFT by a vector (i.e., y=\hat{F}_{M}u with u∈ [symbol] ^{M}), 0 multiplier can be obtained for N=16, and

$$Nr - \frac{33}{8} N + 2$$

multipliers for N≥32. Thus, the multiplication count can be obtained as in (4) above, based on the computation of the scaled ADVM algorithm (from FIG. 7).

Based on equations (2) and (4), it can be concluded that the multiplication complexity of the 8-point scaled DVM is also 4N−2 (see also, Coelho et al., supra.).

The scaled ADVM algorithm (FIG. 7) has the linear order (i.e. multiplication complexity of O(N)) as opposed to the FFT-like O(N log N) complexity algorithms, for N=16 to 1024. On the other hand, the DVM is an approximate algorithm as opposed to an exact DVM algorithm. The detailed counts are provided in the table in FIG. 4, which shows the numerical results for the multiplication complexity (the gain-delay blocks) of the scaled ADVM algorithm in Lemma III.6 compared to the direct matrix-vector computations and the radix-2 exact DVM algorithm. The matrix sizes in the comparison range vary from 16×16 to 1024×1024. Consider the direct computation of the scaled DVM by a vector for gain-delay blocks as (N−I)², where the number of gain-delay blocks being denoted by #m (sdvm) in order to compute the exact scaled DVM algorithm presented in Perera et al., 2022 (supra.). The percentage reduction, P_{A}, and P_{L}, of the gain-delay block counts of the scaled ADVM algorithm (FIG. 7) as opposed to O(N log N) complexity exact DVM algorithm in Perera et al., 2022 (supra.) and the brute-force matrix-vector calculation, respectively, can be determined. The values in the last column of the table in FIG. 4 were obtained using

$${P}_{L} = ( \frac{Td - Ta}{Td} ) \times 100 \% ,$$

where Td is the gain-delay block counts in computing the direct matrix-vector product and Ta is the gain-delay block counts in computing the ADVM algorithm. The values in the second-to-last column in the table in FIG. 4 were obtained using

$${P}_{A} = ( \frac{Te - Ta}{Te} ) \times 100 \% ,$$

where Te is the gain-delay block counts of the DVM algorithm in Perera et al., 2022 (supra.) and Ta is the gain-dela block counts in computing the ADVM algorithm.

The table in FIG. 4 shows that the scaled ADVM algorithm requires a significantly low number of gain-delay blocks compared to the brute-force calculation. When the size of the matrices increases, a significant reduction in multiplication complexity (equivalently, delay-gain blocks) can be observed for computing the algorithms of FIGS. 7 and 8. It can also be observed that the scaled ADVM algorithm (FIG. 7) has a low number of gain-delay blocks compared to the exact DVM algorithm with O(N log N) complexity in Perera et al., 2022 (supra.). Because the radix-2 DVM algorithm was used to execute with the ADVM algorithm, it could be observed that the percentage reduction of complexity will be lower when the size of the matrices gets bigger.

The algorithms of many fast transforms often arise from a recursive structure. The FFT has been dubbed the butterfly algorithm, based on the symmetric, butterfly-like patterns that appear when the algorithm is represented visually in a graph. Such graphs illustrate how signals or data are processed at each stage of an algorithm, and their signal flow graphs. These graphs are used as a tool to design and improve algorithms and can be utilized as a building block for IC design. Thus, an SFG can be used to denote the 16-point ADVM algorithm in FIG. 3. With these SFGs, it is straightforward to verify the multiplication and addition complexity of the algorithm for a given value of N, by simply counting the number of convergences as additions, and the number of elements above the arrows as multiplications, or gain-delay block counts. Therefore, the SFG can be utilized for implementing the 16-point scaled ADVM algorithm directly in IC design.

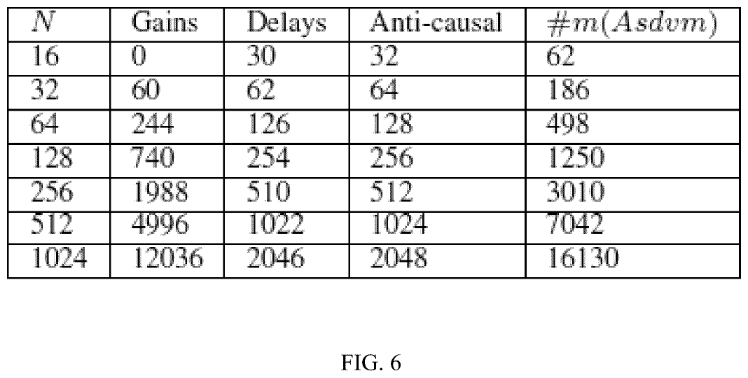

Following the gain-delay blocks in Lemma 2.5 and the building blocks of the SFG shown in FIG. 3, the explicit gains (without counting the multiplication by ±1 and ±j), delays, and total multiplication (i.e., gain-delay block counts in computing the scaled ADVM algorithm) are shown in the second, third, and last columns, respectively, of the table shown in FIG. 6. The fourth column of the table shows the non-trivial anti-causal counts (see also Perera et al., 2022, supra.), which are equivalent to the number of entries in the pre-computed matrix [symbol] _{M}. The trivial anti-causal counts arise from the product of the scaled DFT matrix \tilde{F}_{M} by a vector c with entries of the form e^{jkωτ}, where t is a delay,

$$k = \frac{p}{2}$$

and p is a non-negative integer.

Because these counts are calculated in the pre-computation stage of the algorithm, only the non-trivial anti-causal counts are included in the table in FIG. 6. To realize trivial anti-causal counts (i.e., entries of c), every entry in c was multiplied by the largest magnitude of the

$$( i . e . , \vert {α}^{\frac{- {( N - 1 )}^{2}}{2}} \vert )$$

anti-casual term in the pre-computation stage so that anti-causal terms are not a problem for practical realizations. To exemplify, consider the simplest transfer function P(ω)=e^{jωτ}+e^{-jωτ}. The same magnitude function can be obtained by modifying P(ω) to P′(ω)=1+e^{-2ωτ}, which is simply the original filter with extra latency t.

Multibeam true time delay beamformers have circuit complexity levels proportional to the number of amplifiers and delay-lines in the multibeam beamforming network. A direct realization of an N-beam beamformer has amplifier/gain and delay-line complexity proportional to O(N²) for an N-element N-beam system. Embodiments of the subject invention provide an N-point ADVM algorithm that utilizes highly sparse factors in an approximate computing framework, reducing the gain-delay complexity of the DVM-vector product to a new low of O(N). The reduction of complexity (e.g., by a further factor of log N) has massive benefits; for example, for 1024 beams, that is a 10-times reduction.

Embodiments can provide N TTD beams on an N-element array at amplifier/gain and delay circuit complexity reduced from the original of O(N²) down to O(N). The ADVM algorithm (FIG. 7) executes recursively with the ADFT algorithms (an important aspect), as ADFTs enable reducing DFT complexity down from O(N log N) for usual FFTs to a lower value of O(N), via sparse matrix factorization of the ADFT matrix. An exact FFT (see also Perera et al., 2022, supra.) can be replaced with an O(N) fast-factorized ADFT to reach this remarkable result. The resulting recursion leads to a reduction in the gain-delay complexity of the DVM-vector product to a linear order, which is the first time this has been achieved. The ability to form large numbers of TTD multibeams over an antenna array aperture having N-elements, with circuit complexity scaling as O(N) (i.e. linear growth), instead of the usual quadratic growth, can significantly enhance the practical realizability of wideband multi-antenna beamforming systems in the future, including mm Wave and FutureG wireless systems, massive MIMO wireless systems, radar and electronic warfare, and RF imaging applications.

Embodiments of the subject invention provide a focused technical solution to the focused technical problem of how to reduce the complexity of DVMs utilized by TTD multibeam beamformers. The solution is provided by utilizing an ADVM algorithm (e.g., an N-point ADVM) that utilizes highly sparse factors, thereby reducing the gain-delay complexity (e.g., of the DVM-vector product) to a linear order (i.e., O(N)), and when parallelized across p processors, the overall complexity is further reduced to O(N/p). The disclosed algorithm can operate at baseband or IF, where the processing frequency is significantly lower than the RF signal frequency. This enables the use of lower-speed, lower-cost components with relaxed analog and digital performance requirements, thereby reducing circuit complexity, power consumption, and system cost. In particular, the use of an ADFT within the ADVM framework allows efficient multibeam wideband beamforming with scalable complexity and real-time performance. The ADFT reduces the need for exact DFT computations, which are computationally expensive and hardware-intensive. As a result, the overall beamformer architecture benefits from lower chip area, improved power efficiency, and better suitability for integration into commercial wireless systems. Accordingly, embodiments of the invention improve the beamformer itself, both as a hardware system and as a computational structure, by reducing DVM complexity, offloading processing requirements, and facilitating high-performance, cost-effective implementation in baseband and/or IF domains.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When the term module is used herein, it can refer to software and/or one or more algorithms to perform the function of the module; alternatively, the term module can refer to a physical device configured to perform the function of the module (e.g., by having software and/or one or more algorithms stored thereon).

When ranges are used herein, combinations and subcombinations of ranges (including any value or subrange contained therein) are intended to be explicitly included. When the term “about” or “approximately” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg. A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

In the context of approximations for scaled DVM, qualitatively, a scaled ADVM, ÂN, is a transform matrix such that ŷ=Â_{N}z≈y=Ã_{N}Z. In essence, the exact and approximate transform-domain signals are closely related in a quantifiable manner. An approximate matrix must fulfill the following conditions: (i) preserving key properties of the exact matrix; (ii) maintaining mathematical proximity with the exact matrix; and (iii) significantly reducing computational costs compared to the exact DVM-vector product computation.

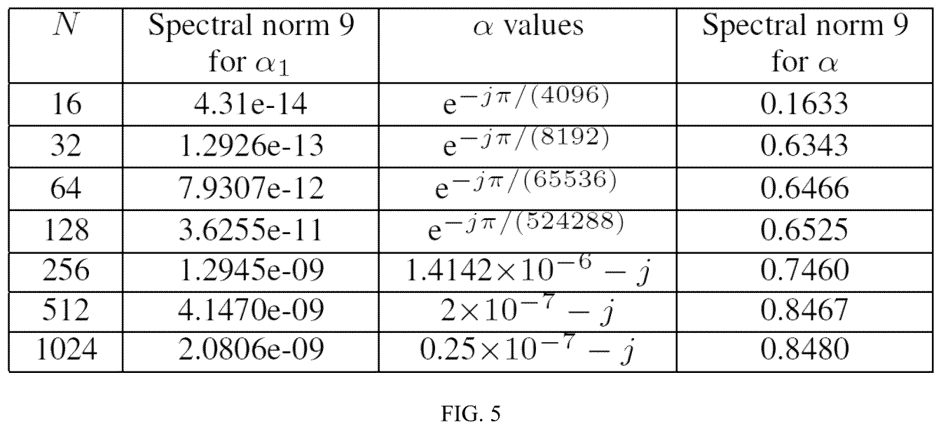

To ensure the accurate interpretation of the approximate spectrum, scaled ADVMs can be sought that closely resemble the associated exact scaled DVMs. A way to achieve this is by minimizing the difference between the exact and the scaled ADVMs, through a matrix norm. This minimization process should also take into account the constraint of maintaining low complexity. The matrix norms satisfy the equivalence property, so one could spectral (2-norm), Frobenius, which is compatible with the 2-norm of a vector-valued form, 1-norm, or ∞-norm. Thus, a possible minimization problem can be proposed of deriving a scaled ADVM for the best possible α∈ [symbol] via

$${min}_{α ∈ ℂ} {‖ {\tilde{A}}_{N} - {{A}^{⌢}}_{N} ‖}_{2} , \qquad ( 6 )$$

where ∥·∥₂ is the spectral norm. As a result of this, numerical results will be presented based on the equation (6) to minimize the difference between the exact and the scaled ADVMs through the table shown in FIG. 5.

The values in the table shown in FIG. 5 were obtained in the IEEE floating point format with the significant decimal digits precision of 10-16. Thus, for many α, α₁ ∈ [symbol] values, the ADVM shows the proximity to the exact scaled DVM with the minimum spectral norm while preserving the DVM structure along with the execution of the O(N) complexity of the Asdvm16 and Asdvm algorithms. Thus, the countable α∈ [symbol] values in the table in FIG. 5 show that the exact DVM and scaled ADVM in the transform-domain signals are closely related in a quantifiable manner.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A beamformer, comprising:
a plurality of antennas, the plurality of antennas being a plurality of radio frequency (RF) antennas configured to receive RF signals;
a plurality of amplifiers respectively connected to the plurality of antennas;
a plurality of filters respectively connected to the plurality of amplifiers; and
a plurality of converters respectively connected to the plurality of filters,
the beamformer being a true time delay (TTD) multibeam beamformer,
the beamformer utilizing a delay Vandermonde matrix (DVM) to describe delay and sum operations in beamforming of the beamformer,
the DVM utilized by the beamformer having a complexity of O(N), and
the beamformer being implemented at baseband or an intermediate frequency (IF), the baseband or the IF being lower in frequency than the RF signals, thereby facilitating a scalable beamforming architecture with simplified circuit design, reduced signal processing overhead, and minimized system cost.

2. The beamformer according to claim 1, the DVM being configured to operate at the baseband or the IF via performing down-conversion operations of the RF signals to the baseband or the IF, thereby facilitating spatial modulation of matrix elements.

3. The beamformer according to claim 2, the RF signals being down-converted to the baseband by mixing the RF signals with a cosine wave, or the RF signals being down-converted to the IF by mixing the RF signals with a sinusoidal wave, and
the down-conversion operations being applicable to both receive-mode systems and transmit-mode systems, thereby enabling a unified architecture that reduces hardware complexity.

4. The beamformer according to claim 1, further comprising:
a signal flow graph implementing an O(N) delay-amplifier algorithm, the signal flow graph being modified by appending a phase-rotator having a β value to each α delay element value of the signal flow graph, where each α delay element value corresponds to a delay line of the signal flow graph and each β value corresponds to an amplification of the signal flow graph.

5. The beamformer according to claim 1, further comprising a chip electrically connected to the plurality of antennas, the chip running an approximated DVM (ADVM) algorithm to generate output beamformed signals at the baseband or the IF,
the ADVM algorithm being implemented using at least one approximate discrete Fourier transform (ADFT) to perform wideband multibeam beamforming to reduce computational complexity to O(N), and
computations of the at least one ADFT being distributed across p parallel processors to reduce the computational complexity to O(N/p), thereby enabling concurrent processing of signal components and improving overall processing efficiency.

6. The beamformer according to claim 1, the beamformer being configured for wireless systems with fractional bandwidths below approximately 30%, thereby reducing implementation complexity and deployment cost relative to full-bandwidth TTD beamformers.

7. The beamformer according to claim 1, the beamformer being operable in continuous-time or discrete-time modes using analog signal processing, digital signal processing, switched-capacitor techniques, and/or switched-current techniques, thereby enabling cost-effective, flexible, and power-efficient implementations.

8. The beamformer according to claim 1, the beamformer being mapped to custom standard cell libraries, and
the beamformer being taped out by completing a digital integrated circuit (IC) layout for fabrication.

9. The beamformer according to claim 1, the beamformer being embedded in radio access network (RAN) hardware, and
the beamformer being configured to be used in massive multiple-input multiple-output (MIMO), fifth-generation (5G), sixth-generation (6G), Next Generation (NextG), Future Generation (FutureG), holographic MIMO, full-duplex, and integrated communications and sensing systems.

10. The beamformer according to claim 1, further comprising:
analog integrated circuits based on complementary metal-oxide-semiconductor (CMOS) techniques and multiple semiconductor technologies;
discrete-time digital processing circuitry employing at least one of Von Neumann architectures, graphics processing units (GPUs), matrix-vector processing methods, tensor cores, systolic arrays, and analog-digital hybrid techniques including compute-in-memory; and
digital logic implemented on at least one of digital signal processors (DSPs), field programmable gate arrays (FPGAs), and radio frequency system-on-chip (RF SoC) platforms using hardware description language (HDL) coding,
thereby enabling scalable, energy-efficient, real-time beamforming.

11. A method of generating an N-beam true time delay (TTD) beamformer based on sparse factorization of a delay Vandermonde matrix (DVM) for a low complexity O(N) algorithm, the method comprising:
a) providing the beamformer, the beamformer comprising:
a plurality of antennas, the plurality of antennas being a plurality of radio frequency (RF) antennas configured to receive RF signals;
a plurality of amplifiers respectively connected to the plurality of antennas;
a plurality of filters respectively connected to the plurality of amplifiers; and
a plurality of converters respectively connected to the plurality of filters,
b) electrically connecting a chip to the plurality of antennas;
c) implementing beamforming at baseband or an intermediate frequency (IF) lower in frequency than the RF signals, thereby facilitating a scalable beamforming architecture with simplified circuit design, reduced signal processing overhead, and minimized system cost; and
d) running an approximate DVM (ADVM) algorithm on the chip in order to reduce the complexity of the DVM utilized by the beamformer to O(N), the beamformer being a true time delay (TTD) multibeam beamformer.

12. The method according to claim 11, step c) comprising the sub-steps of:
performing down-conversion operations of the RF signals to the baseband or the IF, thereby facilitating spatial modulation of matrix elements;
mixing the RF signals with a cosine wave for the baseband or mixing the RF signals with a sinusoidal wave for the IF; and
applying the down-conversion operations to both receive-mode systems and transmit-mode systems, thereby enabling a unified architecture that reduces hardware complexity.

13. The method according to claim 11, further comprising:
prior to step d), generating a signal flow graph configured to implement an O(N) delay-amplifier algorithm; and modifying the signal flow graph by appending a phase-rotator having a β value to each α delay element value, where each α delay element value corresponds to a delay line of the signal flow graph and each β value corresponds to an amplification of the signal flow graph.

14. The method according to claim 11, step d) comprising the sub-steps of:
generating output beamformed signals by applying the ADVM algorithm at the baseband or the IF;
applying at least one approximate discrete Fourier transform (ADFT) to perform wideband multibeam beamforming to reduce computational complexity to O(N); and
distributing computations of the at least one ADFT computations across p parallel processors to reduce the computational complexity to O(N/p), thereby enabling concurrent processing of signal components and improving overall processing efficiency.

15. The method according to claim 11, the beamformer being configured for wireless systems having fractional bandwidths below approximately 30%, thereby reducing implementation complexity and deployment cost relative to full-bandwidth TTD beamformers.

16. The method according to claim 11, further comprising:
operating the beamformer in continuous-time or discrete-time modes using analog signal processing, digital signal processing, switched-capacitor and/or switched-current techniques, thereby enabling cost-effective, flexible, and power-efficient implementations.

17. The method according to claim 11, further comprising:
mapping the beamformer to custom standard cell libraries; and
taping out the beamformer by completing a digital integrated circuit (IC) layout for fabrication.

18. The method according to claim 11, further comprising:
embedding the beamformer in radio access network (RAN) hardware,
the beamformer being configured to be used in massive multiple-input multiple-output (MIMO), fifth-generation (5G), sixth-generation (6G), Next Generation (NextG), Future Generation (FutureG), holographic MIMO, full-duplex, and integrated communication and sensing systems.

19. The method according to claim 11, further comprising:
implementing the beamformer using analog integrated circuits based on complementary metal-oxide-semiconductor (CMOS) techniques and multiple semiconductor technologies;
implementing discrete-time digital processing using circuitry employing at least one of Von Neumann architectures, graphics processing units (GPUs), matrix-vector processing methods, tensor cores, systolic arrays, and analog-digital hybrid techniques including compute-in-memory; and
implementing digital logic on at least one of digital signal processors (DSPs), field programmable gate arrays (FPGAs), and radio frequency system-on-chip (RF SoC) platforms using hardware description language (HDL) coding,
thereby enabling scalable, energy-efficient, real-time beamforming.

20. A beamformer, comprising:
a plurality of antennas, the plurality of antennas being a plurality of radio frequency (RF) antennas configured to receive RF signals;
a plurality of amplifiers respectively connected to the plurality of antennas;
a plurality of filters respectively connected to the plurality of amplifiers; and
a plurality of converters respectively connected to the plurality of filters,
the beamformer being a true time delay (TTD) multibeam beamformer,
the beamformer utilizing a delay Vandermonde matrix (DVM) to describe delay and sum operations in beamforming of the beamformer,
the DVM utilized by the beamformer having a complexity of O(N), and
the beamformer being implemented at baseband or an intermediate frequency (IF), the baseband or the IF being lower in frequency than the RF signals, thereby facilitating a scalable beamforming architecture with simplified circuit design, reduced signal processing overhead, and minimized system cost,
the DVM being configured to operate at the baseband or the IF via performing down-conversion operations of the RF signals to the baseband or the IF, thereby facilitating spatial modulation of matrix elements,
the RF signals being down-converted to the baseband by mixing the RF signals with a cosine wave, or the RF signals being down-converted to the IF by mixing the RF signals with a sinusoidal wave, and the down-conversion operations being applicable to both receive-mode systems and transmit-mode systems, thereby enabling a unified architecture that reduces hardware complexity,
the beamformer further comprising a signal flow graph implementing an O(N) delay-amplifier algorithm, the signal flow graph being modified by appending a phase-rotator having a β value to each α delay element value, where each α delay element value corresponds to a delay line of the signal flow graph and each β value corresponds to an amplification of the signal flow graph,
the beamformer further comprising a chip electrically connected to the plurality of antennas, the chip running an approximate DVM (ADVM) algorithm to generate output beamformed signals at the baseband or the IF,
the ADVM algorithm being implemented using at least one approximate discrete Fourier transform (ADFT) to perform wideband multibeam beamforming to reduce computational complexity to O(N),
computations of the at least one ADFT being distributed across p parallel processors to reduce the computational complexity to O(N/p), thereby enabling concurrent processing of signal components and improving overall processing efficiency,
the beamformer being configured for wireless systems with fractional bandwidths below approximately 30%, thereby reducing implementation complexity and deployment cost relative to full-bandwidth TTD beamformers,
the beamformer being operable in continuous-time or discrete-time modes using analog signal processing, digital signal processing, switched-capacitor techniques, and/or switched-current techniques, thereby enabling cost-effective, flexible, and power-efficient implementations,
the beamformer being mapped to custom standard cell libraries,
the beamformer being taped out by completing a digital integrated circuit (IC) layout for fabrication,
the beamformer being embedded in radio access network (RAN) hardware,
the beamformer being configured to be used in massive multiple-input multiple-output (MIMO), fifth-generation (5G), sixth-generation (6G), Next Generation (NextG), Future Generation (FutureG), holographic MIMO, full-duplex, and integrated communications and sensing systems, and
the beamformer further comprising:
analog integrated circuits based on low-cost complementary metal-oxide-semiconductor (CMOS) techniques and multiple semiconductor technologies;
discrete-time digital processing circuitry employing at least one of Von Neumann architectures, graphics processing units (GPUs), matrix-vector processing methods, tensor cores, systolic arrays, and analog-digital hybrid techniques including compute-in-memory; and
digital logic implemented on at least one of digital signal processors (DSPs), field programmable gate arrays (FPGAs), and radio frequency system-on-chip (RF SoC) platforms using hardware description language (HDL) coding,
thereby enabling scalable, energy-efficient, real-time beamforming.
